(19) United States
(12) Patent Application Publication
(10) Pub. No.: US 2025/0322303 A1
(43) Pub. Date: Oct. 16, 2025

(54) DATA COLLECTION DEVICE, LEARNING DEVICE, AND DATA COLLECTION METHOD

(71) Applicant: ANALYTICWARE, INC., Tokyo (JP)

(72) Inventor: Kimio MOMOSE, Tokyo (JP)

(21) Appl. No.: 18/866,330

(22) PCT Filed: May 10, 2023
(86) PCT No.: PCT/JP2023/017530

§ 371 Date: Nov. 15, 2024

(30) Foreign Application Priority Data
May 17, 2022 (JP) 2022-080608
Jul. 11, 2022 (JP) 2022-111223

(51) Int. Cl. G06N 20/00

(52) U.S. Cl. CPC G06N 20/00

(57) ABSTRACT

A data collection apparatus includes: a source information storage unit configured to store first training data source information from which training data is formed; a source information transmission unit configured to transmit the first training data source information to two or more user terminals; a source information reception unit configured to receive second training data source information that contains input information input by a user for the first training data source information, from a user terminal, in association with the first training data source information; a training data forming unit configured to form training data, using the first training data source information and the second training data source information; and an accumulation unit configured to accumulate the training data formed by the training data forming unit, by providing a platform for collecting training data used to build a machine learning model.

### TECHNICAL FIELD

The present invention relates to, for example, a data collection apparatus that collects training data for forming a machine learning model.

### BACKGROUND ART

Conventionally, there have been machine learning techniques for predicting objects contained in images and classifying information (for example, see Non-Patent Document 1).

### CITATION LIST

### Non-Patent Document

Non-Patent Document 1: “TensorFlow”, [online], [searched on April 30, 2022], the Internet [URL: https://www.tensorflow.org/?hl=ja]

### SUMMARY OF INVENTION

### Technical Problem

However, conventional techniques usually require a large amount of training data to build a machine learning model, and it is not easy to form or collect such a large amount of training data.

### Solution to Problem

A data collection apparatus according to a first aspect of the present invention is a data collection apparatus including: a source information storage unit configured to store first training data source information from which training data used to build a learning model through machine learning processing is formed; a source information transmission unit configured to transmit the first training data source information to two or more user terminals; a source information reception unit configured to receive second training data source information that contains input information input by a user for the first training data source information transmitted by the source information transmission unit and processed by a user terminal, in association with the first training data source information; a training data forming unit configured to form training data to be used in machine learning processing, using the first training data source information and the second training data source information received by the source information reception unit; and an accumulation unit configured to accumulate the training data formed by the training data forming unit.

With this configuration, it is possible to provide a platform for collecting training data used to build a machine learning model.

A data collection apparatus according to a second aspect of the present invention is the data collection apparatus according to the first aspect of the invention, wherein the first training data source information contains element information that constitutes the training data, the second training data source information is a label identifying the element information and input by a user for the element information, and the training data contains the element information and the label.

With this configuration, it is possible to provide a platform for collecting training data used to build a learning model for predicting, from element information, the label of the element information.

A data collection apparatus according to a third aspect of the present invention is the data collection apparatus according to the first aspect of the invention, wherein the first training data source information contains element information that constitutes the training data, the second training data source information is conversion information obtained by converting the element information and input by the user for the element information, and the training data contains the element information and the conversion information.

With this configuration, it is possible to provide a platform for collecting training data used to build a learning model for predicting, from element information, conversion information converted from the element information.

A data collection apparatus according to a fourth aspect of the present invention is the data collection apparatus according to the third aspect of the invention, wherein the element information is a term or a sentence in a first language, and the conversion information is a term or a sentence in a second language.

With this configuration, it is possible to provide a platform for collecting training data used to build a learning model for predicting conversion information obtained by translating the element information in the first language into the second language.

A data collection apparatus according to a fifth aspect of the present invention is the data collection apparatus according to the first aspect of the invention, wherein the first training data source information contains element information that constitutes the training data, the second training data source information is explanatory information that explains the element information and input by the user for the element information, and the training data contains the element information and the explanatory information.

With this configuration, it is possible to provide a platform for collecting training data used to build a learning model for predicting, from element information, explanatory information that explains the element information.

A data collection apparatus according to a sixth aspect of the present invention is the data collection apparatus according to the first aspect of the invention, wherein the first training data source information includes a program that assists the user in inputting the input information, and the source information reception unit receives the second training data source information containing the input information input by the user, after the program is executed in the user terminal.

With this configuration, it is also possible to provide users with a program that assists them in entering input information.

A data collection apparatus according to a seventh aspect of the present invention is the data collection apparatus according to the sixth aspect of the invention, wherein the program is a machine learning prediction program that predicts a label of element information, the first training data source information contains element information that constitutes the training data, the second training data source information contains a label acquired by executing the prediction program on the element information and corrected by the user, and the training data contains the element information and the label.

With this configuration, it is possible to provide a platform for easily collecting training data used to build a learning model for predicting, from element information, the label of the element information.

A data collection apparatus according to an eighth aspect of the present invention is the data collection apparatus according to the sixth aspect of the invention, the program is a conversion program that converts element information, the first training data source information contains element information that constitutes the training data, the second training data source information contains conversion information acquired by executing the prediction program on the element information and corrected by the user, and the training data contains the element information and the conversion information.

With this configuration, it is possible to provide a platform for easily collecting training data used to build a learning model for predicting, from element information, conversion information converted from the element information.

A data collection apparatus according to a ninth aspect of the present invention is the data collection apparatus according to the eighth aspect of the invention, wherein the conversion program is a machine translation program, the element information is a term or a sentence in a first language, and the conversion information is a term or a sentence in a second language.

With this configuration, it is possible to provide a platform for easily collecting training data used to build a learning model for predicting conversion information obtained by translating the element information in the first language into the second language.

A data collection apparatus according to a tenth aspect of the present invention is the data collection apparatus according to the sixth aspect of the invention, wherein the program is a machine learning prediction program that predicts explanatory information of element information, the first training data source information contains element information that constitutes the training data, the second training data source information contains explanatory information acquired by executing the prediction program on the element information and corrected by the user, and the training data contains the element information and the explanatory information.

With this configuration, it is possible to provide a platform for easily collecting training data used to build a learning model for predicting, from element information, explanatory information that explains the element information.

A data collection apparatus according to an eleventh aspect of the present invention is the data collection apparatus according to the sixth aspect of the invention, wherein the program is a program that assists in acquiring positive and negative examples that constitute the training data, and the second training data source information is constituted by positive examples and negative examples acquired by the user terminal using the program.

With this configuration, it is possible to provide a platform for collecting training data used to build a machine learning model for judging between positive and negative examples.

A data collection apparatus according to a twelfth aspect of the present invention is the data collection apparatus according to any one of the first to eleventh aspects of the invention, wherein the source information transmission unit transmits the same first training data source information to two or more user terminals, the source information reception unit receives the second training data source information corresponding to the same first training data source information from the two or more user terminals, and the training data forming unit forms the training data to be accumulated, using pieces of input information respectively contained in the two or more pieces of second training data source information received by the source information reception unit in accordance with a predetermined algorithm.

With this configuration, it is possible to provide a platform for collecting training data used to build an accurate learning model.

A data collection apparatus according to a thirteenth aspect of the present invention is the data collection apparatus according to the twelfth aspect of the invention, wherein the training data forming unit includes: a combining part configured to combine pieces of input information respectively contained in the two or more pieces of second training data source information received by the source information reception unit to acquire combined input information; and a training data forming part configured to form training data that contains element information contained in the first training data source information and the combined input information.

With this configuration, it is possible to provide a platform for collecting training data used to build an accurate learning model.

A data collection apparatus according to a fourteenth aspect of the present invention is the data collection apparatus according to any one of the first to thirteenth aspects of the invention, wherein the first training data source information is associated with a data attribute value, the data collection apparatus further includes: a user information storage unit configured to store, for each user one or more pieces of user information each containing one or more user attribute values; and a user determination unit configured to determine one or more pieces of user information each containing a user attribute value corresponding to the data attribute value, and the source information transmission unit transmits the first training data source information to user terminals respectively corresponding to the one or more pieces of user information determined by the user determination unit.

With this configuration, it is possible to acquire second training data source information input by an appropriate user.

A data collection apparatus according to a fifteenth aspect of the present invention is the data collection apparatus according to any one of the first to fourteenth aspects of the invention, further including: an other-terminal transmission unit configured to transmit the second training data source information received by the source information reception unit to another terminal other than the user terminal to which the second training data source information has been transmitted; an evaluation result reception unit configured to receive an evaluation result for the second training data source information from the other terminal; and a judgment unit configured to judge whether or not the evaluation result satisfies an adoption condition, wherein the training data forming unit forms the training data using second training data source information corresponding to the evaluation result only when the judgment unit judges that the adoption condition is satisfied.

With this configuration, it is possible to provide a platform for collecting training data used to build an accurate learning model.

A data collection apparatus according to a sixteenth aspect of the present invention is the data collection apparatus according to the fifteenth aspect of the invention, further including: a user evaluation unit configured to acquire a user evaluation that is an evaluation for a user corresponding to the second training data source information corresponding to the evaluation result, using the evaluation result; and a user evaluation output unit configured to output the user evaluation.

With this configuration, it is possible to evaluate the user who provides the second training data source information.

A data collection apparatus according to a seventeenth aspect of the present invention is the data collection apparatus according to any one of the first to sixteenth aspects of the invention, further including: a reward acquisition unit configured to acquire reward information that specifies a reward corresponding to transmission of the second training data source information from the user terminal; and a reward accumulation unit configured to accumulate the reward information in association with a user who uses the user terminal.

With this configuration, it is possible to give a reward to the user who provides the second training data source information.

A data collection apparatus according to an eighteenth aspect of the present invention is the data collection apparatus according to any one of the first to sixteenth aspects of the invention, further including: an other-terminal transmission unit configured to, when the source information reception unit receives second training data source information from the user terminal, transmit input information received from another user terminal to the user terminal.

With this configuration, another piece of input information can be transmitted to the user who transmitted the input information in order to confirm the correctness of the other piece of input information, making it easier to acquire a fair evaluation of the other piece of input information from the user.

A data collection apparatus according to a nineteenth aspect of the present invention is the data collection apparatus according to the eighteenth aspect of the invention, further including: an evaluation result reception unit configured to receive, from the user terminal, an evaluation result for input information transmitted by the other-terminal transmission unit; and a processing unit configured to accumulate the evaluation result in association with the input information and perform different processing on the input information depending on the evaluation result.

With this configuration, another piece of input information can be transmitted to the user who transmitted the input information in order to confirm the correctness of the other piece of input information, making it easier to acquire a fair evaluation of the other piece of input information from the user.

A learning apparatus according to a twentieth aspect of the present invention is a learning apparatus including the data collection apparatus according to any one of the first to nineteenth aspects of the invention; and a learning unit configured to perform machine learning processing using two or more pieces of training data accumulated by the data collection apparatus to acquire a learning model, and accumulate the learning model.

With this configuration, it is possible to easily build a machine learning model.

A prediction apparatus according to a nineteenth aspect of the present invention is the prediction apparatus according to the eighteenth aspect of the invention, including: an acceptance unit configured to accept element information, a learning apparatus; an acceptance unit configured to accept element information; a prediction unit configured to perform machine learning prediction processing to acquire input information, using a learning model acquired by the learning apparatus and the element information accepted by the acceptance unit; and a prediction result output unit configured to output the input information.

With this configuration, it is possible to easily perform machine learning prediction processing, using a learning model.

### Advantageous Effects of Invention

A data collection apparatus according to the present invention provides a platform for collecting training data for building a machine learning model, thereby making it possible to collect a large amount of training data.

### BRIEF DESCRIPTION OF DRAWINGS

FIG. 1 is a conceptual diagram showing a data collection apparatus system A according to a first embodiment.

FIG. 2 is a block diagram showing the data collection apparatus system A according to the same.

FIG. 3 is a block diagram showing a data collection apparatus 1 according to the same.

FIG. 4 is a flowchart illustrating an example of operation of the data collection apparatus 1 according to the same.

FIG. 5 is a flowchart illustrating an example of user determination processing according to the same.

FIG. 6 is a flowchart illustrating an example of training data formation processing according to the same.

FIG. 7 is a flowchart illustrating an example of multiple input information processing according to the same.

FIG. 8 is a flowchart illustrating an example of operation of a user terminal 2 according to the same.

FIG. 9 is a diagram showing a user information management table according to the same.

FIG. 10 is a diagram showing an example of output according to the same.

FIG. 11 is a diagram showing an example of output according to the same.

FIG. 12 is a diagram showing an example of output according to the same.

FIG. 13 is a diagram showing an example of output according to the same.

FIG. 14 is a diagram showing an example of output according to the same.

FIG. 15 is a conceptual diagram showing an information system B according to a second embodiment.

FIG. 16 is a block diagram showing the information system B according to the same.

FIG. 17 is a conceptual diagram showing a computer system according to the above embodiments.

FIG. 18 is a block diagram showing the computer system according to the same.

### DESCRIPTION OF EMBODIMENTS

Hereinafter, embodiments of a data collection apparatus, etc., will be described with reference to the drawings. In the embodiments, components with the same reference numerals perform similar operations, and therefore redundant descriptions may be omitted.

### First Embodiment

The present embodiment describes a data collection apparatus that transmits first training data source information, which is used to form training data, to two or more user terminals, receives second training data source information, which contains input information, from each of the two or more user terminals, forms training data using the first training data source information and the second training data source information, and accumulates the training data.

The present embodiment also describes a data collection apparatus that transmits the same first training data source information to two or more user terminals 2, receives pieces of second training data source information corresponding to the same first training data source information from the two user terminals, respectively, and form and accumulate training data, using the first training data source information and the two or more pieces of second training data source information.

The present embodiment also describes a data collection apparatus that acquires combined input information formed by combining pieces of input information respectively contained in pieces of second training data source information received from two or more user terminals, and forms and accumulates training data that contains the combined input information.

The present embodiment also describes a data collection apparatus that manages user attribute values (for example, the user's specialty is English) for each user terminal and determines the user terminal to which first training data source information is to be transmitted, using the user attribute values.

The present embodiment also describes a data collection apparatus that transmits second training data source information received from a user terminal to another user terminal, receives an evaluation result from the other user terminal, and adopts the second training data source information and forms training data only when the evaluation result satisfies an adoption condition.

The present embodiment also describes a data collection apparatus that can evaluate the user who has transmitted second training data source information, using the above evaluation result.

Furthermore, the present embodiment describes a data collection apparatus that can give a reward to the user who has transmitted second training data source information.

In this specification, “information X being associated with information Y” means that information Y can be obtained from information X, or information X can be obtained from information Y, and there is no limitation on the method of association. Information X and information Y may be linked, may exist in the same buffer, information X may be contained in information Y, or information Y may be contained in information X, etc.

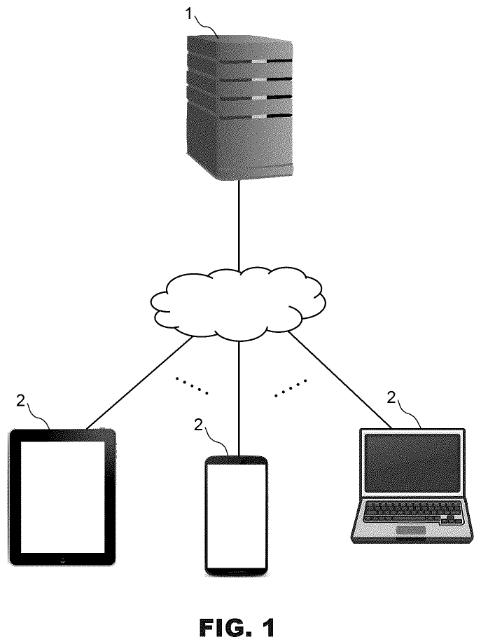

FIG. 1 is a conceptual diagram showing a data collection apparatus system A according to the present embodiment. The data collection apparatus system A includes a data collection apparatus 1 and one or more user terminals 2.

The data collection apparatus 1 is a server for collecting training data. The data collection apparatus 1 is, for example, a so-called server, such as a cloud server or an ASP server.

The user terminals 2 are terminals used by users. The users here are the people who perform the task of forming training data. The users are the people who provide input information, which will be described later. The user terminals 2 are terminals that each receive first training data source information and transmit second training data source information. The user terminals 2 may be, for example, so-called personal computers, tablet terminals, smart phones, or the like, and there is no limitation on their type.

The data collection apparatus 1 and the one or more user terminals 2 can communicate with each other via a network such as the Internet or a LAN.

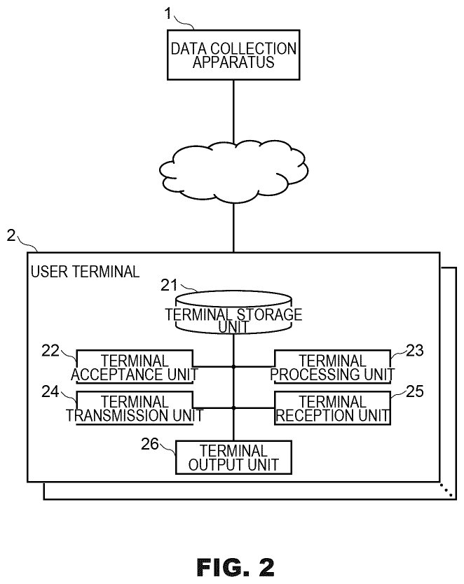

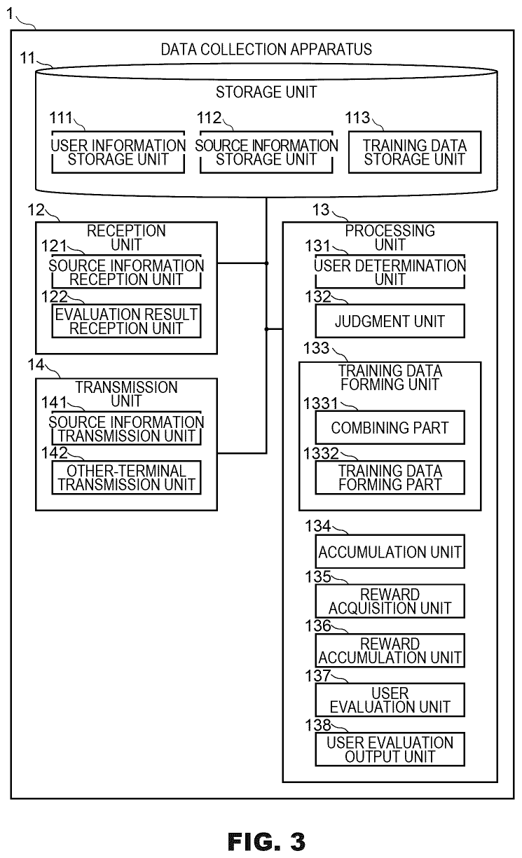

FIG. 2 is a block diagram showing the data collection apparatus system A according to the present embodiment. FIG. 3 is a block diagram showing the data collection apparatus 1.

The data collection apparatus 1 includes a storage unit 11, a reception unit 12, a processing unit 13, and a transmission unit 14. The storage unit 11 includes a user information storage unit 111, a source information storage unit 112, and training data storage unit 113. The reception unit 12 includes a source information reception unit 121 and an evaluation result reception unit 122. The processing unit 13 includes a user determination unit 131, a judgment unit 132, a training data forming unit 133, an accumulation unit 134, a reward acquisition unit 135, a reward accumulation unit 136, a user evaluation unit 137, and a user evaluation output unit 138. The training data forming unit 133 includes a combining part 1331 and a training data forming part 1332. The transmission unit 14 includes a source information transmission unit 141 and an other-terminal transmission unit 142.

Each user terminal 2 includes a terminal storage unit 21, a terminal acceptance unit 22, a terminal processing unit 23, a terminal transmission unit 24, a terminal reception unit 25, and a terminal output unit 26.

The storage unit 11 included in the data collection apparatus 1 stores various kinds of information. Examples of the various kinds of information include user information, which will be described later, first training data source information, which will be described later, training data, which will be described later, and various programs.

The various programs are programs to be executed on the user terminals 2. The various programs are, for example, programs that use element information. The various programs are, for example, programs that perform predetermined processing on element information. The various programs are, for example, a machine learning prediction program, a machine translation program, a speech synthesis program, and a speech recognition program.

The user information storage unit 111 stores one or more pieces of user information. User information is information regarding a user. User information includes, for example, a user identifier and one or more user attribute values. The user identifier is information that identifies the user. The user identifier is, for example, a user ID, a telephone number, an email address, or a user terminal identifier. The user terminal identifier is information that identifies the user terminal 2. The user terminal identifier is, for example, transmission destination information, which is information used to communicate with the user terminal 2. The user terminal identifier is, for example, the IP address, MAC address, or telephone number of the user terminal 2. The user attribute values may be referred to as the characteristics of the user. The user attribute values are, for example, a specialty identifier and a language used. The specialty identifier is information that identifies the specialty of the user. The specialty identifier is, for example, Japanese-English translation (e.g., “1”), Japanese to Chinese translation (e.g., “2”), and English to Japanese translation (e.g., “3”). The language used is the language used by the user. The language used is, for example, Japanese, English, or Chinese. Examples of the user attribute values include reward information, which will be described later, and a user evaluation, which will be described later.

The source information storage unit 112 stores one or more pieces of first training data source information. The first training data source information is source information used to form training data. Training data is information used to form a learning model through a machine learning processing.

For example, an inspection flag, a multi-person flag, and a combination flag may be associated with the first training data source information. The inspection flag is information indicating that the received second training data source information is to be inspected by another user. The multi-person flag is information indicating that the first training data source information is to be transmitted to multiple people. The combination flag is information indicating that the pieces of input information respectively contained in the pieces of second training data source information received from multiple user terminals 2 are to be combined to form combined input information.

Note that the learning model is information formed through machine learning processing, and is information used in machine learning prediction processing. The learning model may also be referred to as a learner, classifier, classification model, or the like. The machine learning algorithm for building a learning model or for performing prediction processing using a learning model may be deep learning, random forest, decision tree, SVM, SVR, or the like, and there is no limitation. In addition, for machine learning, for example, the TensorFlow library, the R language random forest module, various machine learning functions such as fastText and TinySVM, or various existing libraries can be used.

The first training data source information typically includes element information. The element information is information that constitutes training data. The element information is typically information that serves as explanatory variables that constitute the training data, and may also be information that serves as target variables that constitute the training data. The element information is, for example, an image, a video (moving image), sound information, or a character string. The element information is, for example, information to which a label indicating a classification is to be attached (e.g., an image or a video). Note that a label is information that identifies the element information. A label is typically constituted by one or more terms. The element information is, for example, a term to be translated, or one or more sentences to be translated. A term is a set of one or more words. The element information is, for example, information regarding the subject to be explained (e.g., an image or a video). The element information is, for example, sound information (speech data) to be subjected to speech recognition. The element information is, for example, a character string to be subjected to speech synthesis.

It is preferable that the first training data source information contains a program that assists a user in entering input information. Examples of the program that assists in entering input information include a machine learning prediction program that uses element information to predict input information, a machine translation program that performs machine translation on element information in a first language and outputs suggested input information in a second language, a speech synthesis program that performs speech synthesis on element information, which is a character string, and outputs suggested speech data, or a speech recognition program that performs speech recognition processing on element information, which is speech data, and outputs a suggested character string.

It is preferable that the first training data source information is associated with a data attribute value. The data attribute value is an attribute value of the first training data source information or an attribute value of the element information contained in the first training data source information. The data attribute value is, for example, information indicating the first language of the element information to be translated (e.g., “English” or “Japanese”), or information indicating the first language and the second language (e.g., “Japanese to English” or “Chinese to Japanese”).

It is preferable that the first training data source information is associated with reward basis information that serves as the basis for calculating the reward to be given to the user who transmitted the second training data source information. Reward basis information is information that is the serves as the basis for obtaining reward information. The reward basis information is, for example, a unit price for transmitting input information, the amount of reward for one piece of second training data source information, and the number of points to be given for one piece of second training data source information.

The training data storage unit 113 stores one or more pieces of training data. The training data here is the data formed by the training data forming unit 133. The training data here is preferably in a data structure that can be provided directly to the learning module, but does not have to be in a data structure that can be provided directly to the learning module. The training data here preferably contains all the pieces of information contained in the training data in the data structure that is provided directly to the learning module.

The training data contains, for example, element information and input information. The training data contains, for example, element information, and labels, which are input information. A label is information (e.g., “dog”, “cat”, or

“Akita dog”) that identifies element information (e.g., an image capturing an animal). The training data contains, for example, element information (e.g., a sentence in the first language) and conversion information (e.g., a sentence obtained by translating a sentence in the first language into the second language). The training data contains, for example, element information (e.g., an image or a video) and explanatory information (e.g., a sentence that explains an image or a sentence that explains a video).

The reception unit 12 receives various kinds of information. Examples of the various kinds of information include, for example, second training data source information, which will be described later, and an evaluation result, which will be described below.

The source information reception unit 121 receives second training data source information from one or more user terminals 2. These user terminals 2 are terminals to which the source information transmission unit 141, which will be described later, has transmitted the first training data source information.

The second training data source information is source information used to form training data. The second training data source information contains input information. The second training data source information may be input information. The input information is information input by the user in response to the first training data source information processed by the user terminal 2. The input information may be the information itself (e.g., the result of machine translation) output as a result of a program contained in the first training data source information performing processing on the element information, or information output as a result of the program performing processing and then modified by the user. The information input by the user is the information acquired as a result of the user performing an operation on the user terminal 2. The information input by the user may be information manually input by the user, an image or a video captured by the user and imported into the user terminal 2, or speech uttered by the user and imported into the user terminal 2. The information input by the user may be information that has come to exist in the user terminal 2 as a result of some operation by the user.

The processing on the first training data source information is, for example, displaying all or part (e.g., input information) of the first training data source information, performing conversion processing on all or part of the first training data source information, or performing machine learning prediction processing using the first training data source information and a learning model (not shown) to obtain a prediction result. It is preferable that the program that performs conversion processing and the program that performs machine learning prediction processing are included in the first training data source information to be transmitted to the user terminal 2.

The source information reception unit 121 typically receives the second training data source information from the user terminal 2 in a form associated with the first training data source information. The term “in a form associated with the first training data source information” means, for example, that the second training data source information contains a first training data source information identifier. The term “in a form associated with the first training data source information” means, for example, that the second training data source information contains element information. Note that the first training data source information identifier is information that identifies the first training data source information. The information that identifies the first training data source information may be information that identifies the element information contained in the first training data source information.

For example, after a program is executed in a user terminal 2, the source information reception unit 121 receives second training data source information containing input information input by the user. Note that the program here is, for example, a machine learning prediction program that classifies pieces of element information. The program here is, for example, a machine learning prediction program that classifies pieces of element information and a learning model used in prediction processing. The program here is, for example, a machine translation program that performs machine translation on element information. The program here is, for example, a machine learning prediction program that generates explanatory information for element information. The program here is, for example, a machine learning prediction program that generates explanatory information for element information and a learning model used in prediction processing. The program here is, for example, a program that performs speech synthesis processing on element information that is a character string. The program here is, for example, a program that performs speech recognition processing on element information that is a character string. Note that there is no limitation on the type of program.

It is preferable that the source information reception unit 121 receives second training data source information corresponding to the same first training data source information from two or more user terminals.

The second training data source information is, for example, a label that identifies element information and contains a label input by a user for the element information. The second training data source information is, for example, conversion information that is information acquired by converting element information, and contains conversion information input by the user for the element information. The second training data source information is, for example, explanatory information that explains element information, and contains explanatory information input by the user for the element information.

The second training data source information contains, for example, a label acquired by the user correcting the label acquired by executing the prediction program on element information. The second training data source information contains, for example, conversion information acquired by the user correcting the conversion information acquired by executing the prediction program on element information. The second training data source information contains, for example, explanatory information acquired by the user correcting the explanatory information acquired by executing the prediction program on element information.

The second training data source information is constituted by, for example, positive examples and negative examples acquired by the user terminal 2 using a program. Note that this program is a program to which positive and negative examples can be input. This program is a program to which positive and negative examples are input and that transmits to the data collection apparatus 1 the second training data source information containing the positive and negative examples. The input of positive and negative examples may be the capture of an image or video, the input of a character string, or the capture of speech data.

The above-mentioned program is, for example, a machine learning prediction program that predicts the label of element information, a conversion program that converts element information, a machine learning prediction program that predicts explanatory information of element information, or a program that assists in acquiring positive and negative examples that constitute training data.

Note that a positive example is information regarding an object to be identified, such as a photo of a cracked wall or a photo of a building with cracks. A negative example is information that is not a positive example, such as a photo of a wall without cracks or a photo of a building without cracks. However, there is no limitation on the data type, content, etc. of the positive and negative examples. Note that the positive and examples may be reversed.

The evaluation result reception unit 122 receives the evaluation result for the second training data source information from another terminal. Note that the other terminal is a user terminal 2 other than the user terminal 2 that transmitted the second training data source information. The other terminal is a user terminal 2 used by a user who evaluates the second training data source information.

The evaluation result reception unit 122 may receive the evaluation result for the input information transmitted by the other-terminal transmission unit 142 to a user terminal 2, from the user terminal 2. Note that this user terminal 2 is not the user terminal 2 that transmitted the input information.

The evaluation result is information indicating the result of evaluation of the second training data source information or the input information contained in the second training data source information. The evaluation result is, for example, information indicating that the input information contained in the second training data source information or the second training data source information is correct (e.g., true “1”), information indicating that the input information contained in the second training data source information or the second training data source information is incorrect (e.g., false “0”), or correct input information input by the user.

The processing unit 13 performs various kinds of processing. Examples of the various types of processing include processing performed by the user determination unit 131, the judgment unit 132, the training data forming unit 133, the accumulation unit 134, the reward acquisition unit 135, the reward accumulation unit 136, the user evaluation unit 137, and the user evaluation output unit 138.

The processing unit 13 stores the evaluation results received by the reception unit 12 in association with the input information transmitted by the transmission unit 14. Thereafter, depending on one or more accumulated evaluation results, the processing unit 13 performs different processing on the input information corresponding to the evaluation results.

There is no limitation on the content of the different processing performed by the processing unit 13. For example, the processing unit 13 adopts input information corresponding to an evaluation result “correct” as training data, and does not adopt input information corresponding to an evaluation result “incorrect” as training data. When there are two or more evaluation results for one piece of input information, and the result of statistical processing of the two or more evaluation results satisfies a condition (for example, when the number or percentage of evaluation results “correct” is equal to or greater than a threshold value), the processing unit 13 adopts the one piece of input information as training data, and when the condition is not satisfied (for example, when the number or percentage of evaluation results “incorrect” is equal to or greater than a threshold value), the processing unit 13 does not adopt the one piece of input information as training data.

“Adopting information as training data” means, for example, accumulating the information in the training data storage unit 113, or using the information to form a learning model. “Not adopting information as training data” means, for example, not accumulating the information in the training data storage unit 113, or not using the information to form a learning model.

For example, if the evaluation result is “correct”, the processing unit 13 transmits the input information to another user terminal 2, and if the evaluation result is “incorrect”, the processing unit 13 transmits the input information to yet another user terminal 2. When there are two or more evaluation results for one piece of input information, if the result of the statistical processing of the two or more evaluation results satisfies a condition (for example, if the number or percentage of evaluation results “correct” is equal to or greater than a threshold value), the processing unit 13 transmits the input information to another user terminal 2, and if the condition is not satisfied (for example, if the number or percentage of evaluation results is “incorrect” is equal to or greater than a threshold value), the processing unit 13 transmits the input information to yet another user terminal 2.

The user determination unit 131 determines the user terminal 2 to which the first training data source information is to be transmitted. “Determining the user terminal 2” means, for example, acquiring a user identifier or acquiring transmission destination information. Determining the user terminal 2 may mean any processing that can determine the user terminal 2 to which the first training data source information is to be transmitted.

The user determination unit 131 determines, for example, one or more pieces of user information that meet a task condition. The task condition is a condition for performing the task of transmitting input information for the first training data source information. The task condition is that one or more data attribute values satisfy one or more data attribute values paired with the first training data source information. For example, the user determination unit 131 acquires one or more data attribute values that are paired with the first training data source information from the source information storage unit 112, and determines one or more pieces of user information having user attribute values corresponding to the one or more data attribute values. For example, when the data attribute value is “English” (for example, when the first language to be translated is “English”), the user determination unit 131 acquires a user identifier corresponding to the record whose user attribute value “specialty” among the user attribute values is “English to Japanese translation”, from the user information storage unit 111.

For example, the user determination unit 131 randomly determines one or more user terminals 2 from among the candidate user terminals 2 to which the first training data source information is transmitted.

The judgment unit 132 judges whether or not the evaluation result received by the evaluation result reception unit 122 satisfies an adoption condition. The adoption condition is a condition for adopting the second training data source information received by the source information reception unit 121 and forming training data. The adoption condition is a condition indicating that the input information contained in the second training data source information is correct. The adoption condition is, for example, that the evaluation result is “information indicating that the input information is correct” or that the corrected input information contained in the evaluation result is “NULL”.

The training data forming unit 133 forms training data to be used for machine learning processing, using the first training data source information transmitted by the source information transmission unit 141 and the second training data source information received by the source information reception unit 121. Forming training data using first training data source information and second training data source information may also be considered to include forming training data using a portion of the first training data source information and a portion of the second training data source information.

For example, the training data forming unit 133 forms training data, using the element information contained in the first training data source information and the input information contained in the second training data source information. For example, the training data forming unit 133 forms training data, using the element information contained in the first training data source information as an explanatory variable and the input information contained in the training data source information as a target variable. For example, the training data forming unit 133 forms training data, using the element information contained in the first training data source information as an explanatory variable and the input information contained in the training data source information as a target variable. Note that there is no limitation on the data structure of the training data. The training data is, for example, a vector whose elements are the element information and the input information.

The training data forming unit 133 forms training data to be stored, using pieces of input information respectively contained in the two or more pieces of second training data source information received by the source information reception unit 121 in accordance with a predetermined algorithm. Typically, one piece of training data is formed here.

The predetermined algorithm is, for example, majority voting. That is to say, if the pieces of input information respectively contained in the two or more pieces of second training data source information received by the source information reception unit 121 are not all the same information, the training data forming unit 133 determines the most frequently occurring input information as the input information to be used to form the training data. The predetermined algorithm is, for example, a combination method, which will be described later.

It is preferable that the training data forming unit 133 forms training data using the second training data source information corresponding to the evaluation result only when the judgment unit 132 judges that the adoption condition is satisfied.

The combining part 1331 included in the training data forming unit 133 combines pieces of input information respectively contained in the two or more pieces of second training data source information received by the source information reception unit 121 to acquire combined input information. Note that “combination” means acquiring combined input information that contains all or some of two or more pieces of second training data source information among the two or more pieces of second training data source information received by the source information reception unit 121.

For example, the combining part 1331 determines information that contains all of the pieces of input information (e.g., labels that identify images) respectively contained in the two or more pieces of second training data source information received by the source information reception unit 121 as the input information to be used to form the training data. Note that such information, which contains all of the pieces of input information, is combined input information.

For example, the combining part 1331 acquires information that contains all of the pieces of information resulting from unique processing performed on the pieces of input information (e.g., labels that identify images) respectively contained in the two or more pieces of second training data source information received by the source information reception unit 121, as combined input information. In such a case, duplicate pieces of information (e.g., duplicate labels) are removed from the combined input information.

For example, the training data forming part 1332 forms training data that contains the element information contained in the first training data source information and the combined input information acquired by the combining part 1331.

The accumulation unit 134 accumulates the training data formed by the training data forming unit 133. For example, the accumulation unit 134 accumulates the training data in the training data storage unit 113.

The accumulation unit 134 may accumulate the evaluation results received by the evaluation result reception unit 122 in association with the input information. These evaluation results are evaluation results for the associated input information.

The reward acquisition unit 135 acquires reward information that specifies a reward corresponding to the transmission of the second training data source information from a user terminal 2. The reward acquisition unit 135 typically acquires reward information in association with the user corresponding to the user terminal 2. For example, when second training data source information is received, the reward acquisition unit 135 acquires reward basis information that is paired with the first training data source information corresponding to the second training data source information from the source information storage unit 112 and uses the reward basis information to acquire reward information (e.g., the amount of reward or the number of reward points).

It is preferable that the reward differs depending on the first training data source information. For example, the reward is higher when input information that is explanatory information is transmitted for an image that is element information than when input information that is a label is sent for an image that is element information. It is preferable that the reward acquisition unit 135 acquires reward information that provides a higher reward for a larger number of pieces of second training data source information. It is preferable that the reward acquisition unit 135 acquires reward information that provides a higher reward for a higher (better) evaluation result for second training data source information.

The reward accumulation unit 136 accumulates the reward information acquired by the reward acquisition unit 135 in association with the user who uses the user terminal 2 that transmitted the second training data source information. For example, the reward accumulation unit 136 accumulates the pieces of reward information acquired by the reward acquisition unit 135 in the user information storage unit 111 in pairs with the user identifier corresponding to the user terminal 2 that transmitted the second training data source information. “The accumulation of reward information” means, for example, the accumulation of new reward information obtained by adding the pieces of reward information acquired by the reward acquisition unit 135 to the pieces of reward information stored in pairs with the user identifier.

Using one or more evaluation results received by the evaluation result reception unit 122, the user evaluation unit 137 acquires a user evaluation, which is an evaluation of the user (the user who created the input information) corresponding to the second training data source information corresponding to the evaluation results.

The user evaluation unit 137 acquires a user evaluation for which, for example, the greater the number of evaluation results that are “information indicating that the input information is incorrect”, the lower the evaluation of the user corresponding to the input information.

The user evaluation output unit 138 outputs the user evaluation acquired by the user evaluation unit 137. Here, “output” is accumulation on a recording medium, transmission to an external apparatus, or delivery of a processing result to another processing apparatus or another program, but may be a concept that includes, for example, displaying on a display screen, projection using a projector, printing by a printer, and the output of a sound.

For example, the user evaluation output unit 138 accumulates the user evaluation acquired by the user evaluation unit 137 in the user information storage unit 111 in a pair with the user identifier corresponding to the input information corresponding to the user evaluation. The user evaluation output unit 138 transmits, for example, the user evaluation acquired by the user evaluation unit 137 to the user terminal 2 of the user.

The transmission unit 14 transmits various kinds of information. Examples of the various kinds of information include first training data source information and second training data source information.

The source information transmission unit 141 transmits first training data source information, which is the source of the training data, to the user terminal 2. The source information transmission unit 141 typically transmits first training data source information, which is the source of the training data, to two or more user terminals. It is preferable that the source information transmission unit 141 transmits the same first training data source information to two or more user terminals. It is preferable that the source information transmission unit 141 transmits the first training data source information to user terminals 2 corresponding to the one or more pieces of user information determined by the user determination unit 131.

The other-terminal transmission unit 142 transmits the second training data source information received by the source information reception unit 121 to another terminal that is a user terminal 2 different from the user terminal 2 that transmitted the second training data source information.

It is preferable that, in response to the source information reception unit 121 receiving second training data source information from a user terminal 2, the other-terminal transmission unit 142 transmits input information that is different from the input information contained in the second training data source information and has been received from a user terminal 2 other than the user terminal 2, to the user terminal 2 from which the second training data source information has been transmitted. This allows the user who transmitted the second training data source information to immediately evaluate other input information. That is to say, at the time when the user's judgment has not been dulled, other input information can be evaluated, which improves the accuracy of the input information and reduces the fluctuation of the input information (labeling).

The other-terminal transmission unit 142 may transmit only the second training data source information that meets an inspection condition to another terminal.

Note that the inspection condition is the condition for the inspection of the second training data source information. For example, the inspection condition is that the first training data source information transmitted by the source information transmission unit 141 is associated with an inspection flag indicating that the second training data source information is to be inspected. For example, the inspection condition is that the second training data source information is received from a user terminal 2 of a user whose user evaluation is not greater than a threshold value or less than a threshold value (a low evaluation user). However, there is no limitation on the inspection condition.

The terminal storage unit 21 included in each user terminal 2 stores various kinds of information. Examples of the various kinds of information include a user identifier, first training data source information, second training data source information, and various programs.

The terminal acceptance unit 22 accepts various kinds of information, instructions, etc. Examples of the various kinds of information, instructions, etc., include input information, a user operation, an evaluation result for the input information that has been output (second training data source information), a correction for the input information that has been output, and a second transmission instruction. Note that the input information that has been output is candidate input information automatically acquired by a program and is information that may be corrected by a user. A correction to the input information that has been output is input information.

The second transmission instruction is an instruction to transmit, to the data collection apparatus 1, second training data source information that contains input information.

Note that any input means, such as a touch panel, a keyboard, a mouse, a menu screen, or the like, may be employed to input various kinds of information, instructions, etc.

The terminal processing unit 23 performs various kinds of processing. Examples of the various kinds of processing include processing that is performed to convert accepted information, instructions, etc., into information, instructions, etc., with structures to be transmitted. The various kinds of processing include, for example, processing that is performed to convert received information into information with a structure to be output.

For example, the terminal processing unit 23 outputs element information contained in the received first training data source information.

For example, the terminal processing unit 23 executes a program contained in the received first training data source information. Note that executing a program includes executing the program after installing the program.

For example, the terminal processing unit 23 executes a machine learning prediction program on the element information contained in the received first training data source information to acquire a predicted label.

For example, the terminal processing unit 23 executes a conversion program on the element information contained in the received first training data source information to acquire predicted conversion information.

For example, the terminal processing unit 23 executes a machine translation program on the element information contained in the received first training data source information to acquire a predicted translation result.

For example, the terminal processing unit 23 executes a speech recognition program on the element information (speech data) contained in the received first training data source information to acquire a predicted speech recognition result, which is a character string.

For example, the terminal processing unit 23 executes a speech synthesis program on the element information (character string) contained in the received first training data source information to acquire predicted speech data.

For example, the terminal processing unit 23 executes a machine learning prediction program on the element information contained in the received first training data source information to acquire predicted explanatory information.

For example, the terminal processing unit 23 executes a program contained in the received first training data source information, and outputs an input screen used to input positive and negative examples.

For example, the terminal processing unit 23 takes a photo to acquire an image in response to a user operation accepted by the terminal acceptance unit 22. Note that this image is a positive example or a negative example.

The terminal transmission unit 24 transmits various kinds of information, instructions, etc., to the data collection apparatus 1. Examples of the various kinds of information, instructions, etc. include second training data source information.

The terminal reception unit 25 receives various kinds of information from the data collection apparatus 1. Examples of the various kinds of information include first training data source information, second training data source information, and inspection information.

The terminal output unit 26 outputs various kinds of information. Examples of the various kinds of information include first training data source information and second training data source information.

It is preferable that the storage unit 11, the user information storage unit 111, the source information storage unit 112, the training data storage unit 113, the learning model storage unit 31, and the terminal storage unit 21 are realized using a non-volatile recording medium, but they can be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The reception unit 12, the source information reception unit 121, the evaluation result reception unit 122, and the terminal reception unit 25 are typically realized using a wireless or wired communication means, but may be realized using a broadcast reception means.

The processing unit 13, the user determination unit 131, the judgment unit 132, the training data forming unit 133, the accumulation unit 134, the reward acquisition unit 135, the reward accumulation unit 136, the user evaluation unit 137, the user evaluation output unit 138, the combining part 1331, the training data forming part 1332, and the terminal processing unit 23 can typically be realized using a processor, a memory, or the like. The processing procedures performed by the processing unit 13 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation.

The transmission unit 14, the source information transmission unit 141, the other-terminal transmission unit 142, and the terminal transmission unit 24 are typically realized using a wireless or wired communication means, but may be realized using a broadcasting means.

The terminal acceptance unit 22 can be realized using a device driver for the input means such as a touch panel or a keyboard, or control software or the like for controlling the menu screen.

The terminal output unit 26 may be regarded as including or not including an output device such as a display or a speaker. The terminal output unit 26 can be realized using the driver software of the output device, the driver software of the output device and the output device, or the like.

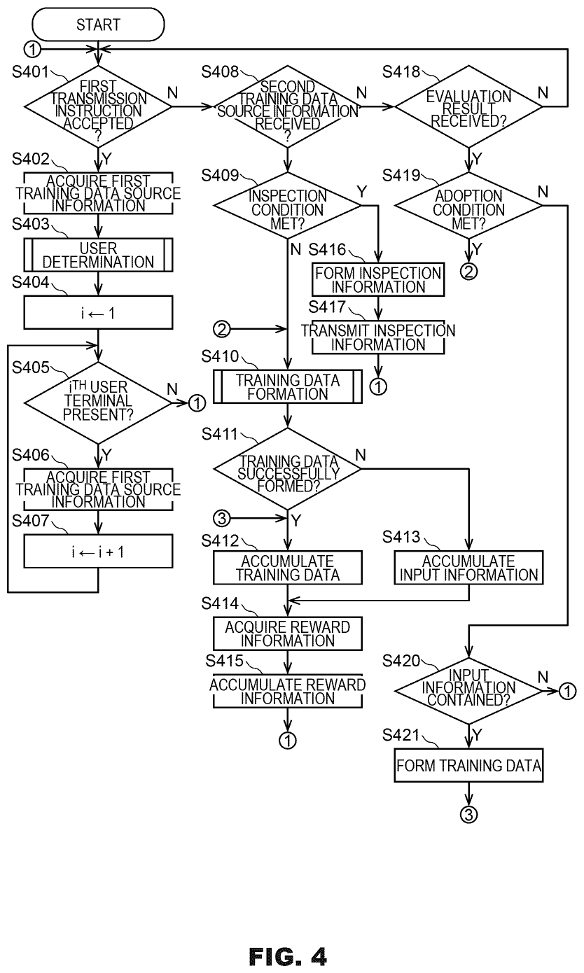

Next, examples of operations of the data collection apparatus system A will be described. First, examples of operations of the data collection apparatus 1 will be described with reference to the flowchart in FIG. 4.

(Step S401) The data collection apparatus 1 judges whether or not a first transmission instruction, which is an instruction to transmit first training data source information, has been accepted. If a first transmission instruction has been accepted, processing proceeds to step S402, and if a first transmission instruction has not been accepted, processing proceeds to step S408. Note that the first transmission instruction is accepted, for example, when the first transmission instruction is received from a terminal of an administrator (not shown) or at a predetermined time. However, there is no limitation on the trigger used to transmit the first training data source information.

(Step S402) The processing unit 13 acquires the first training data source information used to create training data and corresponding to the first transmission instruction, from the source information storage unit 112.

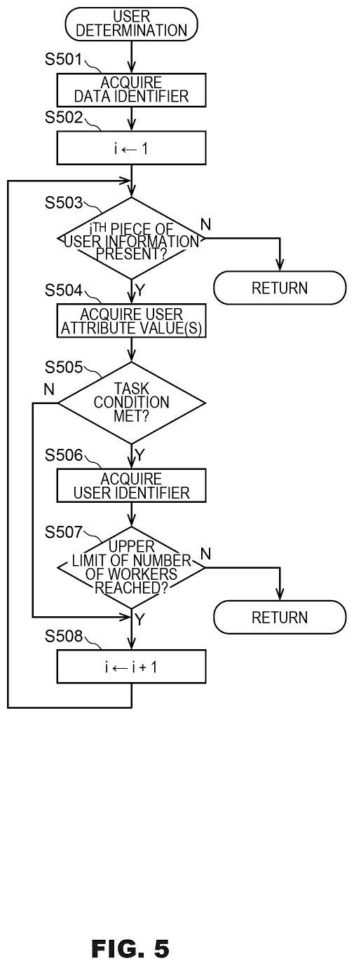

(Step S403) The user determination unit 131 performs user determination processing. Next, an example of user determination processing will be described with reference to the flowchart in FIG. 5. Note that user determination processing is processing that is performed to determine one or more user terminals 2 to which first training data source information is transmitted.

(Step S404) The source information transmission unit 141 substitutes 1 for a counter i.

(Step S405) The source information transmission unit 141 judges whether or not an ith user terminal 2 is present in the user terminals 2 determined in step S403. If the ith user terminal 2 is present, processing proceeds to step S406, and otherwise processing returns to step S401.

(Step S406) The source information transmission unit 141 acquires, from the user information storage unit 111, transmission destination information (for example, the IP address, the MAC address, the email address, or the telephone number) corresponding to the ith user terminal 2. Next, the source information transmission unit 141 transmits the first training data source information acquired in step S402 to the transmission destination indicated by the transmission destination information. It is preferable that the first training data source information to be transmitted contains a first training data source information identifier.

(Step S407) The source information transmission unit 141 increments the counter i by 1. Processing returns to step S405.

(Step S408) The source information reception unit 121 judges whether or not second training data source information has been received from the user terminal 2. If second training data source information has been received, processing proceeds to step S409, and otherwise processing proceeds to step S418.

(Step S409) The judgment unit 132 judges whether or not the second training data source information received in step S408 meets the inspection condition. If the inspection condition is met, processing proceeds to step S416, and if the inspection condition is not met, processing proceeds to step S410.

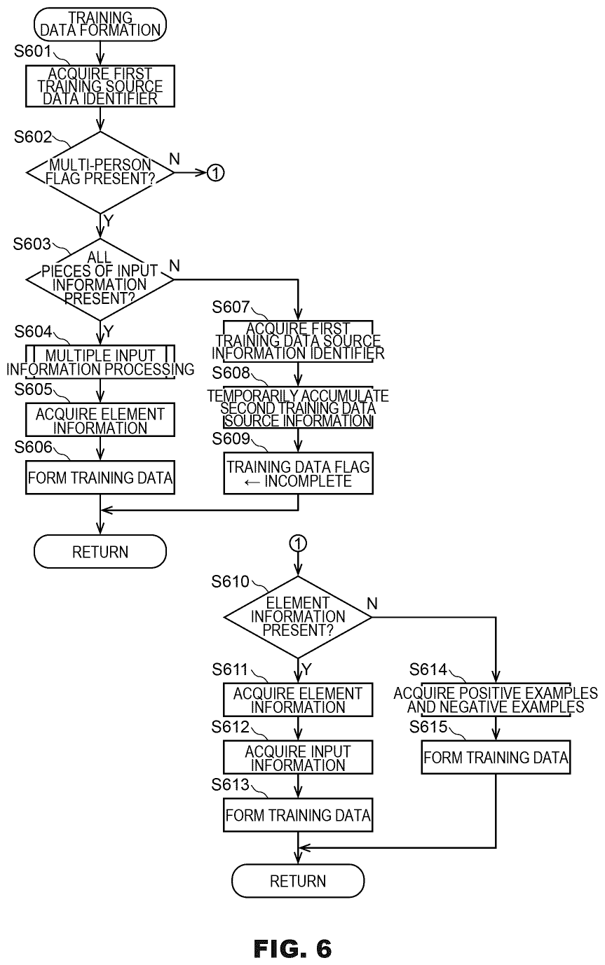

(Step S410) The training data forming unit 133 performs training data forming processing, using the second training data source information received in step S408. An example of training data forming processing will be described with reference to the flowchart in FIG. 6.

(Step S411) The accumulation unit 134 judges whether or not training data has been formed in step S410. If training data has been formed, processing proceeds to step S412, and if training data has not been formed, processing proceeds to step S413.

(Step S412) The accumulation unit 134 accumulates the training data formed in step S410 in the training data storage unit 113. Processing proceeds to step S414. Here, it is preferable that the accumulation unit 134 accumulates the training data in association with the first training data source information from which the training data is formed.

(Step S413) The accumulation unit 134 accumulates, in a buffer (not shown), the input information contained in the second training data source information received in step S408, in association with the first training data source information corresponding to the second training data source information received in step S408.

(Step S414) In response to receiving the second training data source information in step S408, the reward acquisition unit 135 acquires reward information for the user of the user terminal 2 that has transmitted the second training data source information.

(Step S415) The reward accumulation unit 136 accumulates, in the user information storage unit 111, the reward information acquired in step S414, in association with the user identifier of the user of the user terminal 2 that has transmitted the second training data source information. Processing returns to step S401.

(Step S416) Using the second training data source information received in step S408, the processing unit 13 forms inspection information to be transmitted to another terminal. Note that, for example, the inspection information contains second training data source information. For example, the inspection information contains the element information contained in the first training data source information. For example, the inspection information contains element information and input information.

(Step S417) The other-terminal transmission unit 142 acquires, from the user information storage unit 111, transmission destination information regarding the other terminal to which the inspection information is to be transmitted. Next, the other-terminal transmission unit 142 transmits the inspection information to the transmission destination indicated by the transmission destination information. Processing returns to step S401.

Note that the transmission destination information to be acquired may be, for example, transmission destination information of a user who is determined in advance as an inspector (for example, an administrator or a high evaluation user), or transmission destination information of a randomly determined user.

(Step S418) The evaluation result reception unit 122 judges whether or not an evaluation result has been received from the user terminal 2. If an evaluation result has been received, processing proceeds to step S419, and if an evaluation result has not been received, processing returns to step S401. The evaluation result to be received is associated with second training data source information.

(Step S419) The judgment unit 132 judges whether or not the evaluation result received in step S418 meets the adoption condition. If the adoption condition is met, processing proceeds to step S410, and if the adoption condition is not met, processing proceeds to step S420.

(Step S420) The training data forming unit 133 judges whether or not the evaluation result received in step S418 contains corrected input information. If input information is contained, processing proceeds to step S421, and if input information is not contained, processing returns to step S401.

(Step S421) The training data forming unit 133 acquires the input information contained in the evaluation result received in step S418. In addition, the training data forming unit 133 acquires the element information contained in the first training data source information corresponding to the evaluation result received in step S418. Next, the training data forming unit 133 forms training data that contains the element information and the input information. Processing proceeds to step S412.

Note that, in the flowchart shown in FIG. 4, processing is terminated when power is turned off or an interruption is made to terminate the processing.

Next, an example of the user determination processing in step S403 will be described with reference to the flowchart in FIG. 5.

(Step S501) The user determination unit 131 acquires one or more data identifiers paired with the first training data source information, from the source information storage unit 112.

(Step S502) The user determination unit 131 substitutes 1 for the counter i.

(Step S503) The user determination unit 131 judges whether or not an ith user information is present in the user information storage unit 111. If the ith user information is present, processing proceeds to step S504, and otherwise processing returns to higher level processing.

(Step S504) The user determination unit 131 acquires one or more user attribute values contained in the i^{th} user information from the user information storage unit 111.

(Step S505) The user determination unit 131 judges whether or not the one or more data identifiers acquired in step S501 and the one or more user attribute values acquired in step S504 meet a task condition. If the task condition is met, processing proceeds to step S506, and otherwise processing proceeds to step S508.

(Step S506) The user determination unit 131 acquires, from the user information storage unit 111, user identifiers paired with the one or more user attribute values acquired in step S504, and temporarily accumulates them in a buffer (not shown).

(Step S507) The user determination unit 131 judges whether or not the number of user identifiers acquired has reached the upper limit. If the upper limit has been reached, processing returns to higher level processing, and if the upper limit has not been reached, processing proceeds to step S508.

(Step S508) The user determination unit 131 increments the counter i by 1. Processing returns to step S503.

Next, an example of the training data forming processing in step S410 will be described with reference to the flowchart in FIG. 6.

(Step S601) The training data forming unit 133 acquires a first training data source information identifier.

(Step S602) The training data forming unit 133 judges whether or not a multi-person flag is stored in the source information storage unit 112 in a pair with the first training data source information identifier. If the multi-person flag is stored, processing proceeds to step S603, and otherwise processing proceeds to step S610.

(Step S603) The training data forming unit 133 judges whether or not second training data source information that contains input information has been received from all the user terminals 2. If all the pieces of input information are present, processing proceeds to step S604, and otherwise processing proceeds to step S607.

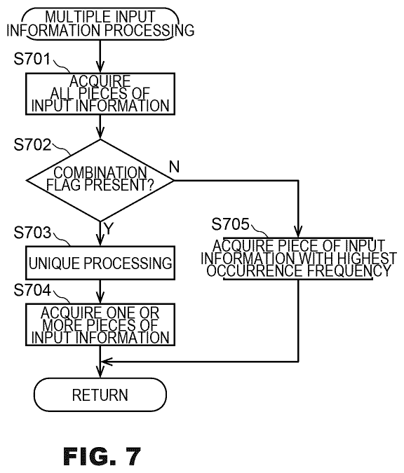

(Step S604) The training data forming unit 133 performs multiple input information processing. An example of multiple input information processing will be described with reference to the flowchart in FIG. 7. Note that multiple input information processing is processing that is performed on multiple pieces of input information for one piece of first training data source information to acquire the input information to be used.

(Step S605) The training data forming unit 133 acquires the element information contained in the first training data source information.

(Step S606) The training data forming unit 133 forms training data that contains the input information acquired in step S604 and the element information acquired in step S605. Processing returns to higher level processing.

(Step S607) The training data forming unit 133 acquires a first training data source information identifier.

(Step S608) The training data forming unit 133 temporarily accumulates the second training data source information received in step S408 in association with the first training data source information identifier acquired in step S607.

(Step S609) The training data forming unit 133 substitutes “incomplete” for the training data flag. Processing returns to higher level processing.

(Step S610) The training data forming unit 133 judges whether or not element information is present in the first training data source information corresponding to the second training data source information received in step S408. If element information is present, processing proceeds to step S611, and if element information is not present, processing proceeds to step S614.

(Step S611) The training data forming unit 133 acquires the element information from the first training data source information corresponding to the second training data source information received in step S408.

(Step S612) The training data forming unit 133 acquires the input information from the second training data source information received in step S408.

(Step S613) The training data forming unit 133 forms training data that contains the input information acquired in step S611 and the element information acquired in step S612. Processing returns to higher level processing.

(Step S614) The training data forming unit 133 acquires positive examples and negative examples from the second training data source information received in step S408.

(Step S615) The training data forming unit 133 forms training data from the positive and negative examples acquired in step S614. Processing returns to higher level processing.

Next, an example of the multiple input information processing in step S604 will be described with reference to the flowchart in FIG. 7.

(Step S701) The training data forming unit 133 acquires all the pieces of input information.

(Step S702) The training data forming unit 133 judges whether or not a combination flag is stored in the source information storage unit 112 in association with the first training data source information. If the combination flag is stored, processing proceeds to step S703, and if the combination flag is not stored, processing proceeds to step S705.

(Step S703) The training data forming unit 133 performs unique processing on all the pieces of input information acquired in step S701.

(Step S704) The training data forming unit 133 acquires one or more pieces of input information, which are the results of the unique processing in step S703. Processing returns to higher level processing.

(Step S705) The training data forming unit 133 acquires one piece of input information with the highest occurrence frequency from among all the pieces of input information acquired in step S701. Processing returns to higher level processing.

Although unique processing is performed on all the pieces of input information in step S703 of the flowchart in FIG. 7, summary processing or the like may also be performed. The processing performed to summarize multiple sentences, which are all the pieces of input information, can be performed by known natural language processing.

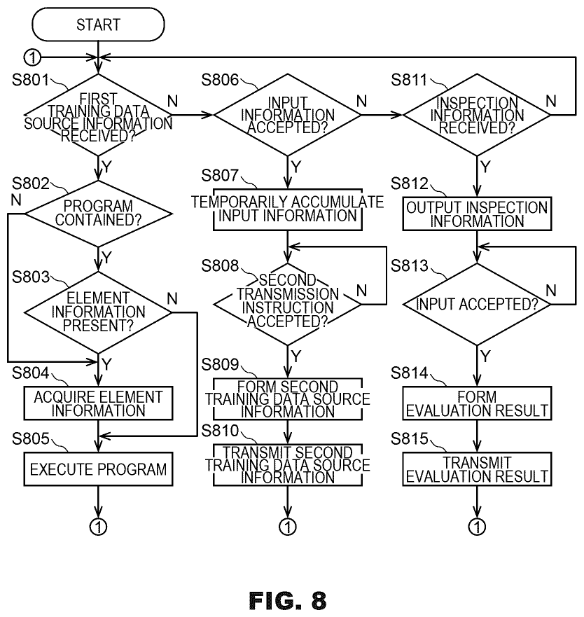

Next, an operation example of each user terminal 2 will be described with reference to the flowchart in FIG. 8.

(Step S801) The terminal reception unit 25 judges whether or not second training data source information has been received from the data collection apparatus 1. If second training data source information has been received, processing proceeds to step S802, and otherwise processing proceeds to step S806. Note that the reception of the second training data source information here may be reception by a user operation (pull-type communication), or reception of the second training data source information by push transmission.

(Step S802) The terminal processing unit 23 judges whether or not the second training data source information received in step S801 contains a program. If a program is contained, processing proceeds to step S803, and if a program is not contained, processing proceeds to step S804.

(Step S803) The terminal processing unit 23 judges whether or not the second training data source information received in step S801 contains element information. If element information is contained, processing proceeds to step S804, and if element information is not contained, processing proceeds to step S805.

(Step S804) The terminal processing unit 23 acquires the element information contained in the second training data source information received in step S801.

(Step S805) The terminal processing unit 23 executes the program contained in the second training data source information received in step S801 or the program stored in the terminal storage unit 21. Note that, here, if element information has been acquired, the terminal processing unit 23 passes the element information to the program and executes the program. Processing returns to step S801.

(Step S806) The terminal acceptance unit 22 judges whether or not input information has been accepted. If input information has been accepted, processing proceeds to step S807, and if input information has not been accepted, processing proceeds to step S811.

(Step S807) The terminal processing unit 23 temporarily accumulates the input information accepted in step S806.

(Step S808) The terminal acceptance unit 22 judges whether or not a second transmission instruction has been accepted. If a second transmission instruction has been accepted, processing proceeds to step S809, and otherwise processing returns to step S808.

(Step S809) The terminal processing unit 23 forms second training data source information that contains the input information accepted in step S806. It is preferable that the second training data source information contains input information and first training data source information and does not contain element information.

(Step S810) The terminal transmission unit 24 transmits the second training data source information formed in step S809 to the data collection apparatus 1. Processing returns to step S801.

(Step S811) The terminal reception unit 25 judges whether or not inspection information has been received from the data collection apparatus 1. If inspection information has been received, processing proceeds to step S812, and if inspection information has not been received, processing returns to step S801.

(Step S812) The terminal processing unit 23 forms inspection information to be output, using the inspection information received in step S811. The terminal output unit 26 outputs the inspection information. Note that the inspection information typically contains element information and input information.

(Step S813) The terminal acceptance unit 22 judges whether or not an input for the output inspection information has been accepted. If an input has been accepted, processing proceeds to step S814, and if an input has not been accepted, processing returns to step S813. Note that the input here is information used to form an evaluation result.

(Step S814) The terminal processing unit 23 forms an evaluation result, using the input accepted in step S813. Note that the evaluation result is, for example, “correct”, “incorrect”, or “corrected input information”.

(Step S815) The terminal transmission unit 24 transmits the evaluation result formed in step S814 to the data collection apparatus 1. Processing returns to step S801.

Note that, in the flowchart shown in FIG. 8, processing is terminated when power is turned off or an interruption is made to terminate the processing.

Hereinafter, specific examples of operations of the data collection apparatus system A according to the present embodiment will be described.

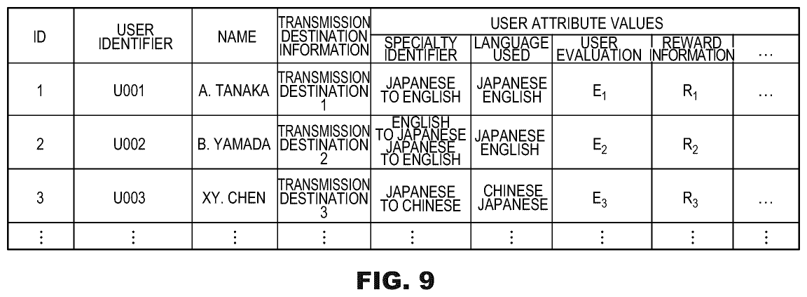

It is assumed that the user information storage unit 111 of the data collection apparatus 1 stores the user information management table shown in FIG. 9. The user information management table manages two or more records each containing “ID”, “user identifier”, “name”, transmission destination information ”, and “user attribute values”. The “user attribute values” here include items “specialty identifier”, “language used”, “user evaluation”, and “reward information”. The “specialty identifier” is information that identifies the user's specialty, and, for example, “Japanese to English” indicates that the user specializes in translating Japanese to English. The “user evaluation” is a symbol here, but is typically a numerical value. The “reward information” is a symbol here, but is typically a numerical value indicating the amount of money or the number of points.

In such a situation, the following four specific examples will be described. Specific Example 1 is a case where a user is requested to translate a difficult Japanese term into English, and second training data source information that contains the difficult Japanese term and the English translation is received from the user terminal 2. Specific Example 2 is a case where multiple users are requested to label an image, second training data source information that contains a label and a first training data source information identifier (the identifier of the image) is received from multiple user terminals 2, and multiple labels are combined. Specific Example 3 is a case where a user is requested to capture and transmit a set of images of an exterior wall with a crack (positive example) and an exterior wall without a crack (negative example), using a user terminal 2. In Specific Example 4, after receiving desired information from a user terminal 2 (for example, an image of an exterior wall with a crack), at least one piece of other desired information (for example, images of an exterior wall with a crack) received from another user terminal 2 is immediately transmitted, and the user is prompted to input an evaluation result as to whether or not the piece of information is the desired information (whether or not there is a crack), the evaluation result is received from the user terminal 2, and the evaluation result is accumulated in association with the transmitted information. When an evaluation result indicating that the information is “desired information”, among one or more accumulated evaluation results, satisfies the adoption condition, the information is adopted. Note that examples of the adoption condition include a condition that the number of evaluation results indicating that the information is “desired information” is not less than a threshold value or greater than a threshold value, and a condition that the proportion of evaluation results indicating that the information is “desired information” is not less than a threshold value or greater than a threshold value.

### Specific Example 1

Here, it is assumed that the storage unit 11 of the data collection apparatus 1 stores a program A (application A) for performing machine translation, entering input information, and transmitting second training data source information.

It is assumed that the data collection apparatus 1 has accepted a first transmission instruction “<difficult term>ICHIREN-TAKUSHOU <data attribute value>Japanese to English”.

Next, the user determination unit 131 acquires the transmission destination information “transmission destination 1” that is paired with the specialty identifier “Japanese to English” that matches the data attribute value “Japanese to English” contained in the first transmission instruction from the user information management table (FIG. 9).

Next, the processing unit 13 acquires the program A from the storage unit 11. The processing unit 13 generates a work ID “W1258” that identifies this task. The processing unit 13 forms first training data source information that contains the program A, the difficult term “ICHIREN-TAKUSHOU”, which is element information, and the work ID “W1258”.

Next, the source information transmission unit 141 transmits the first training data source information to the user terminal 2 of the user A. TANAKA corresponding to the transmission destination information “transmission destination 1”.

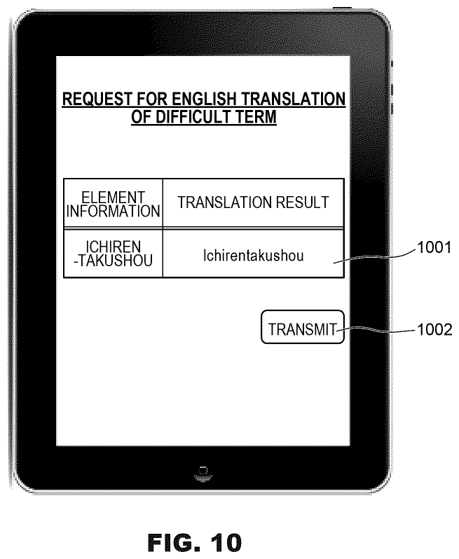

Next, the terminal reception unit 25 of the user terminal 2 of the user A. TANAKA receives the first training data source information from the data collection apparatus 1. Next, the terminal processing unit 23 acquires the element information “ICHIREN-TAKUSHOU” from the received first training data source information. In addition, the terminal processing unit 23 acquires the program A from the received first training data source information. The terminal processing unit 23 passes the element information “ICHIREN-TAKUSHOU” to the program A and executes the program A. It is assumed that, as a result, the screen shown in FIG. 10 is output to the user terminal 2 of the user A. TANAKA. That is to say, it is assumed that the machine translation module contained in the program A translates the Japanese term “ICHIREN-TAKUSHOU” as “Ichirentakushou”.

The automatic translation result of the machine translation module is incorrect. Therefore, it is assumed that the user A. TANAKA enters the correct English translation, “To be in the same boat.”, in place of “Ichirentakushou” in a field 1001 and presses a transmit button 1002.

Next, the terminal processing unit 23 forms second training data source information “<work ID>W1258 <user identifier>U001 <element information>ICHIREN TAKUSHO <input information>To be in the same boat.”. Next, the terminal transmission unit 24 transmits the second training data source information to the data collection apparatus 1.

Next, the source information reception unit 121 of the data collection apparatus 1 receives the second training data source information “<work ID>W1258 <user identifier>U001 <element information>ICHIREN-TAKUSHOU <input information>To be in the same boat.” from the user terminal 2 of the user A. TANAKA.

Next, the processing unit 13 temporarily accumulates the second training data source information “<user identifier>U001 <element information>ICHIREN-TAKUSHOU <input information>To be in the same boat.” in association with the work ID “W1258” in a buffer (not shown).

Next, it is assumed that the judgment unit 132 judges that the received second training data source information meets the inspection condition. Here, it is assumed that the inspection condition is that the user evaluation corresponding to the user identifier is not less than a threshold value. Then, the judgment unit 132 acquires the user evaluation “E₁” paired with the user identifier “U001” from the user information management table (FIG. 9). It is assumed that the judgment unit 132 judges that “E₁<threshold value”.

Next, using the received second training data source information, the processing unit 13 forms inspection information to be transmitted to another terminal, “<work ID>W1258 <element information>ICHIREN-TAKUSHOU <input information>To be in the same boat.” Here, the other-terminal transmission unit 142 acquires the transmission destination information “transmission destination 2” that is paired with the specialty identifier “Japanese to English” that matches the data attribute value “Japanese to English” and is not “transmission destination 1” from the user information management table (FIG. 9). That is to say, the other-terminal transmission unit 142 determines the user terminal 2 of the user B. YAMADA as the other terminal. Next, the other-terminal transmission unit 142 transmits the inspection information to the transmission destination indicated by the transmission destination 2.

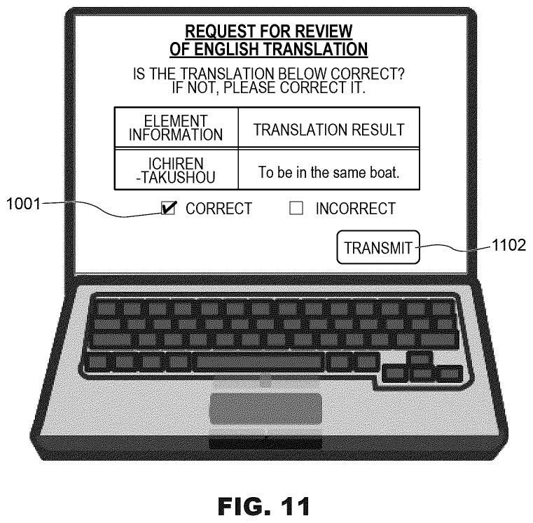

Next, the user terminal 2 of the user B. YAMADA receives and outputs the inspection information. An example of such an output is shown in FIG. 11.

It is assumed that the user B. YAMADA thereafter reviews the translation result, checks the “correct” checkbox 1101, and presses a transmit button 1102.

Next, the terminal acceptance unit 22 of the user terminal 2 accepts such an input from the user B. YAMADA. Next, the terminal processing unit 23 forms an evaluation result “<work ID>W1258 <evaluation result>correct”. Next, the terminal transmission unit 24 transmits the evaluation result to the data collection apparatus 1.

Next, the evaluation result reception unit 122 of the data collection apparatus 1 receives the valuation result “<work ID>W1258 <evaluation result>correct” from the user terminal 2 of the user B. YAMADA.

Next, the judgment unit 132 judges that the received evaluation result “correct” satisfies the adoption condition. Here, it is assumed that the adoption condition is “evaluation result=correct”.

Next, the training data forming unit 133 forms training data (ICHIREN-TAKUSHOU, To be in the same boat.) from the second training data source information “<work ID>W1258 <user identifier>U001 <element information>ICHIREN-TAKUSHOU <input information>To be in the same boat.” Next, the accumulation unit 134 accumulates the training data in the training data storage unit 113.

It is assumed that the above processing is repeatedly performed and a large amount of training data (difficult Japanese terms, English translations of difficult Japanese terms) is accumulated in the training data storage unit 113.

As described above, according to this specific example, it is possible to collect a large amount of training data for building a learning model used to convert difficult Japanese terms into English terms.

### Specific Example 2

Here, it is assumed that the storage unit 11 of the data collection apparatus 1 stores a program B (application B) for outputting a screen having an image, which is element information, and a field used to enter input information, and for transmitting second training data source information.

It is assumed that the data collection apparatus 1 has accepted a first transmission instruction “<image>file1 <number of recipients>3 <combination flag>ON.” It is assumed that “file1” indicates an image file that captures an image of a dog.

Next, the user determination unit 131 acquires, for example, transmission destination information “transmission destination 1”, “transmission destination 2”, and “transmission destination 3” from the user information management table (FIG. 9) in accordance with the number of recipients “3” contained in the first transmission instruction.

Next, the processing unit 13 acquires the program B from the storage unit 11. It is assumed that the processing unit 13 generates the first training data source information identifier (work ID) “W1260”. The processing unit 13 forms first training data source information that contains the job ID “W1260”, the program B, and the image file “file1”, which is element information. The processing unit 13 accumulates a multi-person flag and a combination flag in a pair with the work ID “W1260”.

Next, the source information transmission unit 141 transmits the first training data source information to the user terminals 2 of the users A. TANAKA, B. YAMADA, and XY. CHEN corresponding to the transmission destination information “transmission destination 1”.

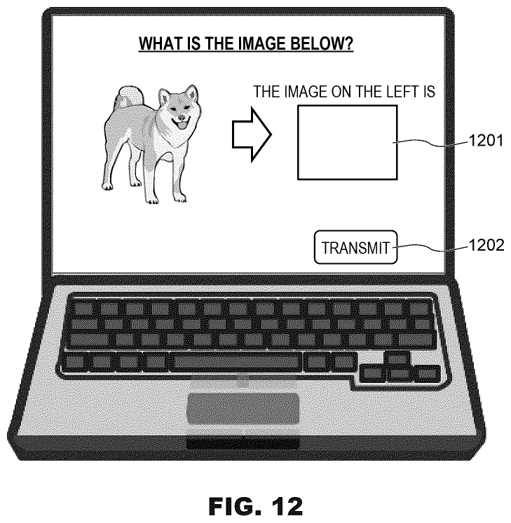

Next, the terminal reception units 25 of the user terminals 2 of the three users receive the first training data source information from the data collection apparatus 1. Next, each terminal processing unit 23 acquires the image file “file1”, which is element information, from the received first training data source information. In addition, the terminal processing unit 23 of each user terminal 2 acquires the program B from the received first training data source information. Each terminal processing unit 23 passes the element information “file1” to the program B and executes the program B. As a result, the screen shown in FIG. 12 is output to the user terminal 2 of each user.

Here, it is assumed that the users A. TANAKA and B. YAMADA enter “Akita dog” in a field 12 to be used to enter input information, and the user XY. CHEN enters “dog” in the field 12 and they press a transmit button 1202. Thereafter, the user terminal 2 of each of the three users forms second training data source information that contains the element information entered in the field 12 and the first training data source information identifier “W1260” and transmits it to the data collection apparatus 1.

Next, the source information reception unit 121 of the data collection apparatus 1 receives the second training data source information from the user terminals 2 of the three users.

Next, the training data forming unit 133 judges that a multi-person flag is stored in the source information storage unit 112 in a pair with the first training data source information identifier “W1260”. Thereafter, the training data forming unit 133 acquires all the pieces of input information “Akita dog, Akita dog, dog”. In addition, the training data forming unit 133 judges that a combination flag is stored in the source information storage unit 112 in association with the first training data source information “W1260”. Next, the training data forming unit 133 performs unique processing on all the acquired pieces of input information to acquire input information “Akita dog, dog”. Next, the training data forming unit 133 acquires the element information (image file “file1”) contained in the first training data source information. Next, the training data forming unit 133 forms training data that contains the input information “Akita dog, dog” and the element information (image file “file1”). Next, the accumulation unit 134 accumulates the training data in the training data storage unit 113.

Here, the input information may be an object variable or an explanatory variable. When the input information is an object variable, the element information is an explanatory variable, and when the input information is an explanatory variable, the element information is an object variable.

It is assumed that the above processing is repeatedly performed and a large amount of training data (images, one or more labels) is accumulated in the training data storage unit 113.

In Specific Example 2, when the input information is one label, the training data forming unit 133 may adopt a majority voting algorithm for all the pieces of input information “Akita dog, Akita dog, dog”, determine the input information to be “Akita dog”, and form training data consisting of the input information “Akita dog” and the image file “file1”.

In Specific Example 2, the program B may contain a machine learning prediction module that identifies images. In such a case, the prediction module is executed on the image file “file1” on the user terminal 2 of each user, and the prediction result of the image (for example, “wolf”) is displayed in a field 1201 of the user terminal 2. The user thereafter reviews and corrects the input information candidate displayed in the field 1201.

As described above, according to this specific example, it is possible to collect a large amount of training data for building a learning model used to label image files.

In addition, according to this specific example, it is possible to collect a large amount of training data for building a learning model used to generate images from labels.

### Specific Example 3

Here, it is assumed that the storage unit 11 of the data collection apparatus 1 stores a program C (application C) that prompts the user to capture images of an area of an exterior wall that has a crack and an area of an exterior wall that does not have a crack and transmits the two captured images.

It is assumed that the data collection apparatus 1 accepts a first transmission instruction “<program>program C”.

It is assumed that the user determination unit 131 next acquires the transmission destination information of all the users from the user information management table (FIG. 9). That is to say, here, a large number of users are asked to perform the following tasks.

Next, the processing unit 13 acquires the program C from the storage unit 11. In addition, the processing unit 13 generates a unique first training data source information identifier (work ID) “W2522” that identifies the first training data source information to be transmitted, and accumulates it in association with the first training data source information. In addition, the processing unit 13 forms first training data source information that contains the first training data source information identifier “W2522” and the program C.

Next, the source information transmission unit 141 transmits the first training data source information to a large number of user terminals 2 corresponding to the large number of pieces of transmission destination information acquired by the user determination unit 131.

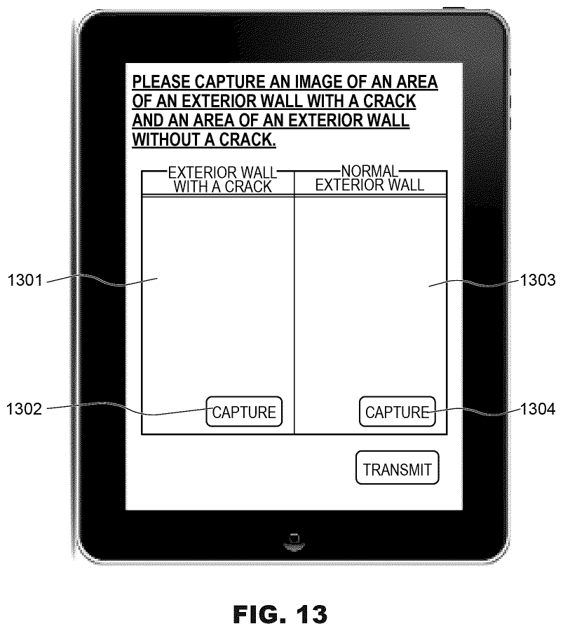

Next, for example, the terminal reception unit 25 of the user terminal 2 of the user A. TANAKA receives the first training data source information from the data collection apparatus 1. Next, the terminal processing unit 23 acquires the program C from the received first training data source information. Next, the terminal processing unit 23 executes the program C. It is assumed that, as a result, the screen shown in FIG. 13 is output to the user terminal 2 of the user A. TANAKA.

It is assumed that the user A. TANAKA turns the screen of the user terminal 2 to an area of an exterior wall with a crack and presses a capture button 1302 to capture an image of the area of the exterior wall with a crack, which is to be entered into an area 1301 in FIG. 13 in accordance with the screen in FIG. 13. It is assumed that the terminal acceptance unit 22 accordingly accepts such an instruction and the terminal processing unit 23 executes the image capturing function of the program C and acquires an image of an area of an exterior wall with a crack.

It is also assumed that the user A. TANAKA turns the screen of the user terminal 2 to an area of an exterior wall without a crack and presses the capture button 1304 to capture an image of the area of the exterior wall without a crack, which is to be entered into an area 1303 in FIG. 13 in accordance with the screen in FIG. 13. It is assumed that the terminal acceptance unit 22 accordingly accepts such an instruction, and the terminal processing unit 23 executes the image capturing function of the program C and acquires an image of an area of an exterior wall without a crack.

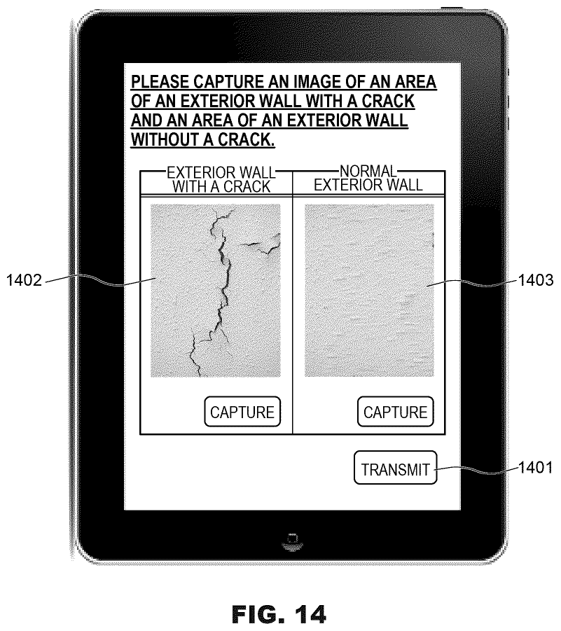

As a result of the above, the user terminal 2 of the user A. TANAKA successfully acquires an image of an area of an exterior wall with a crack (positive example) and an image of an area of an exterior wall without a crack (negative example). An example of such an output is shown in FIG. 14.

It assumed that the user A. TANAKA next presses a transmit button 1401 on the screen of the user terminal 2. Next, the terminal acceptance unit 22 accepts a second transmission instruction. Next, the terminal processing unit 23 forms second training data source information that contains the captured positive example image 1402 and negative example image 1403, and the first training data source information identifier “W2522”. Next, the terminal transmission unit 24 transmits the second training data source information to the data collection apparatus 1.

In addition, it is assumed that another user, like the user A. TANAKA, captures an image of an area of an exterior wall with a crack (positive example) and an image of an area of an exterior wall without a crack (negative example) and transmit the second training data source information to the data collection apparatus 1.

Next, the source information reception unit 121 of the data collection apparatus 1 receives second training data source information from a large number of user terminals 2.

Next, the training data forming unit 133 acquires positive example images and negative example images from the pieces of second training data source information respectively transmitted from the user terminals 2. Next, the training data forming unit 133 forms a large amount of training data, which is sets of the acquired positive example images and negative example images.

Next, the accumulation unit 134 accumulates the large number of pieces of training data thus formed in the training data storage unit 113.

Here, it is preferable that the accumulation unit 134 accumulates the positive example images and negative example images transmitted from the user terminals 2 in the training data storage unit 113 in association with each other. However, it is also possible to simply accumulates the images in the training data storage unit 113 without associating the positive example images and the negative example images with each other so that each image can be distinguished as being a positive example image or a negative example image. Note that even when accumulating positive example images and negative example images in association with each other, the accumulation unit 134 accumulates the images in such a way that it is possible to distinguish which is a positive example image and which is a negative example image.

As described above, according to this specific example, it is possible to collect a large amount of training data for building a learning model used to identify the presence or absence of cracks in an exterior wall.

### Specific Example 4

It is assumed that images of exterior walls with cracks described in the Specific Example 3 (for example, 1402 in FIG. 14) are received from a large number of user terminals 2 and accumulated.

It is assumed that, now, the source information reception unit 121 of the data collection apparatus 1 has received, from the user terminal 2 of a user U, second training data source information that contains input information A (for example, an image of a wall with a crack). Thereafter, the accumulation unit 134 of the data collection apparatus 1 accumulates the second training data source information. Next, the other-terminal transmission unit 142 transmits, to the user terminal 2 of the user U, input information X received from another user terminal 2.

After transmitting the second training data source information, the user terminal 2 of the user U immediately receives and outputs the input information X from the data collection apparatus 1.

It is assumed that the user U next views the input information X output to the user terminal 2, judges that it does not appear to contain a crack, and inputs an evaluation result “incorrect”. Next, the user terminal 2 accepts the evaluation result “incorrect” and transmits the evaluation result “incorrect” to the data collection apparatus 1 in a pair with the identifier of the input information X (for example, “X”).

Next, the evaluation result reception unit 122 of the data collection apparatus 1 receives the evaluation result “incorrect” for the input information X from the user terminal 2. Thereafter, the accumulation unit 134 accumulates the evaluation results received by the evaluation result reception unit 122 in association with the input information X.

It is assumed that such processing is performed not only by the user U but also by a large number of other users. It is assumed that, as a result, a large number of evaluation results are accumulated in association with the input information X.

Next, if the ratio of valuation results “correct” is not less than a threshold value, the processing unit 13 accumulates the input information X in the training data storage unit 113 in order to adopt it as training data. Note that such accumulation may be performed by the accumulation unit 134.

As described above, according to this example, it is possible to provide an environment in which after transmitting input information, the user can immediately evaluate other input information, making it easier for the user to evaluate input information. As a result, appropriate training data can be collected.

As described above, according to the present embodiment, it is possible to provide a platform for collecting training data used to build a machine learning model.

In addition, according to the present embodiment, it is possible to provide a platform for collecting training data used to build a learning model for predicting, from element information, the label of the element information.

In addition, according to the present embodiment, it is possible to provide a platform for collecting training data used to build a learning model for predicting, from element information, the label of the element information.

In addition, according to the present embodiment, it is possible to provide a platform for collecting training data used to build a learning model for predicting conversion information obtained by translating the element information in the first language into the second language.

In addition, according to the present embodiment, it is possible to provide a platform for collecting training data used to build a learning model for predicting, from element information, explanatory information that explains the element information.

In addition, according to the present embodiment, it is also possible to provide users with a program that assists them in entering input information.

In addition, according to the present embodiment, it is possible to provide a platform for collecting training data used to build an accurate learning model.

In addition, according to the present embodiment, it is possible to acquire second training data source information input by an appropriate user.

In addition, according to the present embodiment, it is possible to evaluate the user who provides the second training data source information.

In addition, according to the present embodiment, it is possible to provide an environment that makes it easier to evaluate input information.

Furthermore, according to the present embodiment, it is possible to give a reward to the user who provides the second training data source information.

Note that the processing in the present embodiment may be realized using software. This software may be distributed through software downloading or the like. Also, this software may be recorded on a recording medium such as a CD-ROM and distributed. Note that the same applies to the other embodiments in the present description. Note that the software that realizes the data collection apparatus 1 according to the present embodiment is the program described below. That is to say, this program is a program that enables a computer that can access a source information storage unit configured to store first training data source information from which training data used to build a learning model through machine learning processing is formed to function as: a source information transmission unit that transmits the first training data source information to two or more user terminals; a source information reception unit that receives second training data source information that contains input information input by a user for the first training data source information transmitted by the source information transmission unit and processed by the user terminal, from the user terminal, in association with the first training data source information; a training data forming unit that forms training data to be used in machine learning processing, using the first training data source information and the second training data source information received by the source information reception unit; and an accumulation unit that accumulates the training data formed by the training data forming unit.

### Second Embodiment

The present embodiment describes a learning apparatus that builds a learning model, using multiple pieces of training data collected by the data collection apparatus 1.

The present embodiment also describes a prediction apparatus that performs prediction processing, using a learning model built by the learning apparatus.

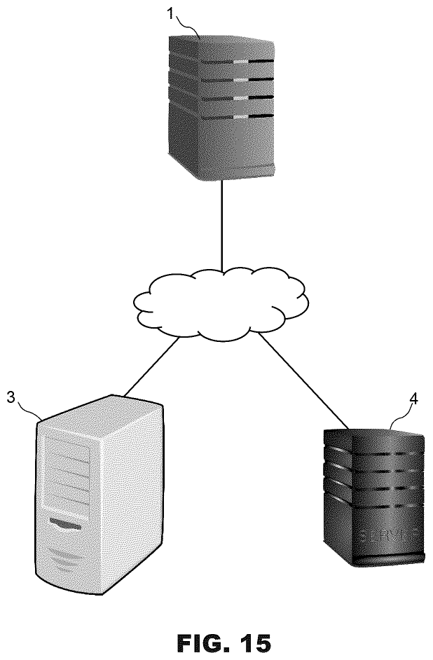

FIG. 15 is a conceptual diagram showing an information system B according to the present embodiment. The information system B includes the data collection apparatus 1, a learning apparatus 3, and a prediction apparatus 4.

The learning apparatus 3 and the prediction apparatus 4 are, for example, so-called servers, such as cloud servers or ASP servers. However, the learning apparatus 3 and the prediction apparatus 4 may be stand-alone apparatuses.

Here, the data collection apparatus 1, the learning apparatus 3, and the prediction apparatus 4 can communicate with each other via a network such as the Internet or a LAN.

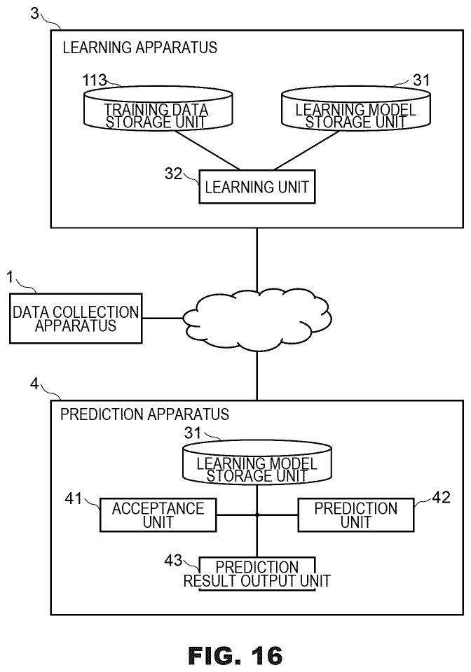

FIG. 16 is a block diagram showing the information system B according to the present embodiment. The learning apparatus 3 includes a training data storage unit 113, a learning model storage unit 31, and a learning unit 32. The prediction apparatus 4 includes a learning model storage unit 31, an acceptance unit 41, a prediction unit 42, and a prediction result output unit 43.

The learning unit 32 included in the learning apparatus 3 performs machine learning processing using two or more pieces of training data accumulated by the data collection apparatus 1 to acquires a learning model, and accumulates the learning model. It is preferable that the learning unit 32 accumulates the learning model in the learning model storage unit 31.

The machine learning algorithm for building a learning model may be deep learning, random forest, decision tree, SVM, SVR, or the like, and there is no limitation. In addition, for machine learning, for example, the TensorFlow library, the R language random forest module, various machine learning functions such as fastText and TinySVM, or various existing libraries can be used.

The acceptance unit 41 included in the prediction apparatus 4 accepts element information. Examples of element information include an image to be labeled, a term or sentence in the first language to be translated, an image to be explained, and a captured image of an exterior wall to be judged whether or not it has a crack.

The “acceptance” here is a concept that includes, for example, acceptance of information input from an input device such as a keyboard, a mouse, or a touch panel, reception of information transmitted via a wired or wireless communication network, acceptance of information read out from a recording medium such as an optical disk, a magnetic disk, or a semiconductor memory, and acquisition of an image by image capturing.

Any input means, such as a touch panel, a keyboard, a mouse, a menu screen, or the like, may be employed to input element information.

The prediction unit 42 performs machine learning prediction processing using the learning model in the learning model storage unit 31 and the element information accepted by the acceptance unit 41, to acquire input information.

The machine learning algorithm for performing prediction processing may be deep learning, random forest, decision tree, SVM, SVR, or the like, and there is no limitation. In addition, for machine learning, for example, the TensorFlow library, the R language random forest module, various machine learning functions such as fastText and TinySVM, or various existing libraries can be used.

The prediction result output unit 43 outputs the input information acquired by the prediction unit 42. Here, “output” is a concept that encompasses accumulation on a recording medium, transmission to an external apparatus, delivery of a processing result to another processing apparatus or another program, displaying on a display screen, projection using a projector, printing by a printer, the output of a sound, and the like.

It is preferable that the learning model storage unit 31 is realized using a non-volatile recording medium, but it can be realized using a volatile recording medium.

There is no limitation on the process in which information is stored in the learning model storage unit 31. For example, information may be stored in the learning model storage unit 31 via a recording medium, or information transmitted via a communication line or the like may be stored in the learning model storage unit 31, or information input via an input device may be stored in the storage unit 11 or the like.

The learning unit 32 and the prediction unit 42 can typically be realized using a processor, a memory, or the like. The processing procedures performed by the learning unit 32 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation. The acceptance unit 41 can be realized using a device driver for the input means such as a touch panel or a keyboard, or control software or the like for controlling the menu screen.

It is preferable that the acceptance unit 41 is realized using a wireless or wired communication means, but they may be realized using a broadcast receiving means, a device driver for an input means such as a touch panel or a keyboard, a control software for a menu screen, or the like.

The prediction result output unit 43 can be realized using a wireless or wired communication means, or realized using the driver software of the output device, the driver software of the output device and the output device, or the like. In such a case, the prediction result output unit 43 may be regarded as including or not including an output device such as a display or a speaker.

Note that the data collection apparatus 1 may include the learning model storage unit 31 and the learning unit 32 of the learning apparatus 3. The data collection apparatus 1 may also include the acceptance unit 41, the prediction unit 42, and the prediction result output unit 43 of the prediction apparatus 4.

As described above, according to the present embodiment, it is possible to build a learning model, using collected training data.

In addition, according to the present embodiment, input information predicted using a learning model can be output.

Note that the software that realizes the learning apparatus 3 according to the present embodiment is the program described below. That is to say, this program is a program that enables a program that can access two or more pieces of training data accumulated by a data collection apparatus to function as: a learning unit that performs machine learning processing, using the two or more pieces of training data, to acquire a learning model, and accumulates the learning model.

The software that realizes the prediction apparatus 4 according to the present embodiment is the program described below. That is to say, this program is a program that enables a computer that can access a learning model acquired by the learning apparatus 3 to function as: an acceptance unit that accepts element information; a prediction unit that performs machine learning prediction processing, using the element information accepted by the acceptance unit, to acquire input information; and a prediction result output unit that outputs the input information.

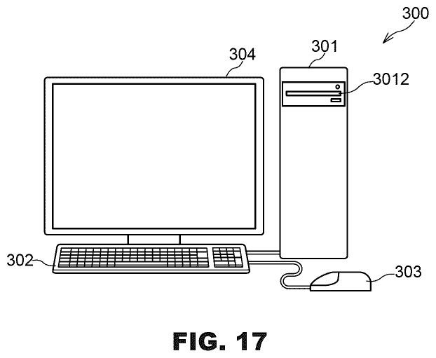

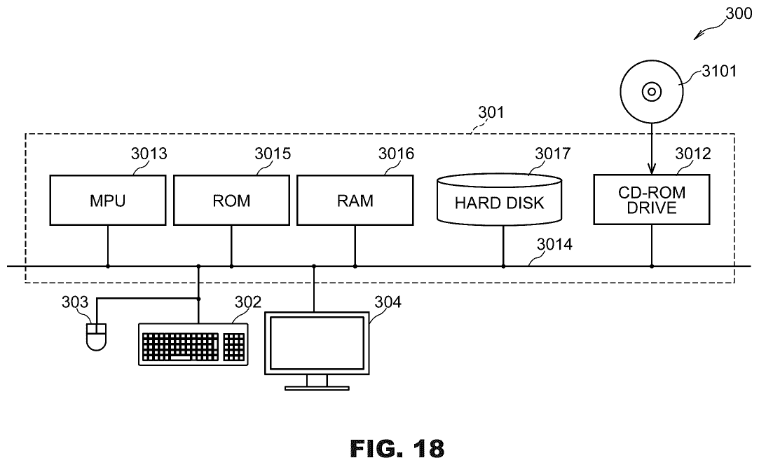

FIG. 17 shows an external appearance of a computer that executes the program described in the present specification and realizes the data collection apparatus 1, the user terminals 2, the learning apparatus 3, and the prediction apparatus 4 according to the various embodiments described above. The above-described embodiments can be realized using computer hardware and a computer program executed thereon. FIG. 17 is an overview diagram for this computer system 300, and FIG. 18 is a block diagram for the system 300.

In FIG. 17, the computer system 300 includes a computer 301 that includes a CD-ROM drive, a keyboard 302, a mouse 303, and a monitor 304.

In FIG. 18, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the data collection apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the data collection apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single computer or multiple computers executing the above-described program. That is to say, centralized processing or distributed processing may be performed.

Also, as a matter of course, in each of the above-described embodiments, two or more communication means that are present in one apparatus may be physically realized using one medium.

Also, in the above-described embodiments, each kind of processing may be realized as centralized processing that is performed by a single apparatus, or distributed processing that is performed by multiple apparatuses.

As a matter of course, the present invention is not limited to the above-described embodiments, and various changes are possible, and such variations are also included within the scope of the present invention.

### Industrial Applicability

As described above, the data collection apparatus 1 according to the present invention has the effect of making it possible to collect a large amount of training data by providing a platform for collecting training data used to build a machine learning model, and is useful as a server or the like that realizes the platform.

1. A data collection apparatus comprising:
a source information storage unit configured to store first training data source information from which training data used to build a learning model through machine learning processing is formed;
a source information transmission unit configured to transmit the first training data source information to two or more user terminals;
a source information reception unit configured to receive second training data source information that contains input information input by a user for the first training data source information transmitted by the source information transmission unit and processed by a user terminal, from the user terminal, in association with the first training data source information;
a training data forming unit configured to form training data to be used in machine learning processing, using the first training data source information and the second training data source information received by the source information reception unit; and
an accumulation unit configured to accumulate the training data formed by the training data forming unit.

2. The data collection apparatus according to claim 1,
wherein the first training data source information contains element information that constitutes the training data,
the second training data source information is a label identifying the element information and input by a user for the element information, and
the training data contains the element information and the label.

3. The data collection apparatus according to claim 1,
wherein the first training data source information contains element information that constitutes the training data,
the second training data source information is conversion information obtained by converting the element information and input by the user for the element information, and
the training data contains the element information and the conversion information.

4. The data collection apparatus according to claim 3,
wherein the element information is a term or a sentence in a first language, and
the conversion information is a term or a sentence in a second language.

5. The data collection apparatus according to claim 1,
wherein the first training data source information contains element information that constitutes the training data,
the second training data source information is explanatory information that explains the element information and input by the user for the element information, and
the training data contains the element information and the explanatory information.

6. The data collection apparatus according to claim 1,
wherein the first training data source information includes a program that assists the user in inputting the input information, and
the source information reception unit receives the second training data source information containing the input information input by the user, after the program is executed in the user terminal.

7. The data collection apparatus according to claim 6,
wherein the program is a machine learning prediction program that predicts a label of element information,
the first training data source information contains element information that constitutes the training data,
the second training data source information contains a label acquired by executing the prediction program on the element information and corrected by the user, and
the training data contains the element information and the label.

8. The data collection apparatus according to claim 6,
the program is a conversion program that converts element information,
the first training data source information contains element information that constitutes the training data,
the second training data source information contains conversion information acquired by executing the prediction program on the element information and corrected by the user, and
the training data contains the element information and the conversion information.

9. The data collection apparatus according to claim 8,
wherein the conversion program is a machine translation program,
the element information is a term or a sentence in a first language, and
the conversion information is a term or a sentence in a second language.

10. The data collection apparatus according to claim 6,
wherein the program is a machine learning prediction program that predicts explanatory information of element information,
the first training data source information contains element information that constitutes the training data,
the second training data source information contains explanatory information acquired by executing the prediction program on the element information and corrected by the user, and
the training data contains the element information and the explanatory information.

11. The data collection apparatus according to claim 6,
wherein the program is a program that assists in acquiring positive and negative examples that constitute the training data, and
the second training data source information is constituted by positive examples and negative examples acquired by the user terminal using the program.

12. The data collection apparatus according to claim 1,
wherein the source information transmission unit transmits the same first training data source information to two or more user terminals,
the source information reception unit receives the second training data source information corresponding to the same first training data source information from the two or more user terminals, and
the training data forming unit forms the training data to be accumulated, using pieces of input information respectively contained in the two or more pieces of second training data source information received by the source information reception unit in accordance with a predetermined algorithm.

13. The data collection apparatus according to claim 12,
wherein the training data forming unit includes:
a combining part configured to combine pieces of input information respectively contained in the two or more pieces of second training data source information received by the source information reception unit to acquire combined input information; and
a training data forming part configured to form training data that contains element information contained in the first training data source information and the combined input information.

14. The data collection apparatus according to claim 1,
wherein the first training data source information is associated with a data attribute value,
the data collection apparatus further comprises:
a user information storage unit configured to store, for each user, one or more pieces of user information each containing one or more user attribute values; and
a user determination unit configured to determine one or more pieces of user information each containing a user attribute value corresponding to the data attribute value, and
the source information transmission unit transmits the first training data source information to user terminals respectively corresponding to the one or more pieces of user information determined by the user determination unit.

15. The data collection apparatus according to claim 1, further comprising:
an other-terminal transmission unit configured to transmit the second training data source information received by the source information reception unit to another terminal other than the user terminal to which the second training data source information has been transmitted;
an evaluation result reception unit configured to receive an evaluation result for the second training data source information from the other terminal; and
a judgment unit configured to judge whether or not the evaluation result satisfies an adoption condition,
wherein the training data forming unit forms the training data using second training data source information corresponding to the evaluation result only when the judgment unit judges that the adoption condition is satisfied.

16. The data collection apparatus according to claim 15, further comprising:
a user evaluation unit configured to acquire a user evaluation that is an evaluation for a user corresponding to the second training data source information corresponding to the evaluation result, using the evaluation result; and
a user evaluation output unit configured to output the user evaluation.

17. The data collection apparatus according to claim 1, further comprising:
a reward acquisition unit configured to acquire reward information that specifies a reward corresponding to transmission of the second training data source information from the user terminal; and
a reward accumulation unit configured to accumulate the reward information in association with a user who uses the user terminal.

18. The data collection apparatus according to claim 1, further comprising:
an other-terminal transmission unit configured to, when the source information reception unit receives second training data source information from the user terminal, transmit input information received from another user terminal to the user terminal.

19. The data collection apparatus according to claim 18, further comprising:
an evaluation result reception unit configured to receive, from the user terminal, an evaluation result for input information transmitted by the other-terminal transmission unit; and
a processing unit configured to accumulate the evaluation result in association with the input information and perform different processing on the input information depending on the evaluation result.

20. A learning apparatus comprising: the data collection apparatus according to claim 1; and a learning unit configured to perform machine learning processing using two or more pieces of training data accumulated by the data collection apparatus to acquire a learning model, and accumulate the learning model.

21. A data collection method realized using a source information storage unit configured to store first training data source information from which training data used to build a learning model through machine learning processing is formed, a source information transmission unit, a source information reception unit, a training data forming unit, and an accumulation unit, comprising:
a source information transmission step in which the source information transmission unit transmits the first training data source information to two or more user terminals;
a source information reception step in which the source information reception unit receives second training data source information that contains input information input by a user for the first training data source information transmitted in the source information transmission step and processed by a user terminal, in association with the first training data source information;
a training data forming step in which the training data forming unit forms training data to be used in machine learning processing, using the first training data source information and the second training data source information received by the source information reception unit; and
an accumulation step in which the accumulation unit accumulates the training data formed in the training data forming step.
